(19) United States
(12) Patent Application Publication
(10) Pub. No.: US 2005/0154723 A1
(43) Pub. Date: Jul. 14, 2005

(54) Advanced search, file system, and intelligent assistant agent

(76) Inventor: Ping Liang, Irvine, CA (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 11/024,325

(22) Filed: Dec. 28, 2004

Related U.S. Application Data
(60) Provisional application No. 60/533,205, filed on Dec. 29, 2003.

(51) Int. Cl. G06F 7/00

(52) U.S. Cl. 707/3

(57) ABSTRACT

The present invention presents embodiments of methods, systems, and computer-readable media for advanced computer file organization, computer file and web search and information retrieval, and intelligent assistant agent to assist a user's creative activities. The embodiments presented herein categorize search results based on the keywords used in the search, provide user selectable ranking, use user's search objectives and advices to refine search, conduct search within an application program and using a file based, provide always-on search that monitors changes over a period of time, provide a high level file system that organizes files into categories, according to relations among files, and in ranking orders along multiple categorization and ranking dimensions and multiple levels of conceptual relationships, conduct searches for associations between keywords, concepts, and propositions, and provide validations of such associations to assist a user's creative activity.

### RELATED APPLICATIONS

This application claims the benefit of U.S. Provisional Application No. 60/533,205, filed Dec. 29, 2003, which is incorporated herein by reference.

### FIELD OF THE INVENTION

The present invention relates to methods and systems for information retrieval, organization and use, and more particularly, to methods and systems for information retrieval on a local computer and over a network, file systems organized to facilitate information retrieval, and automated information retrieval, monitoring and association to assist a user's information collection, research and creative activities.

### BACKGROUND OF THE INVENTION

Computers such as PCs, workstations, and servers, mass storages such as Hard Disk Drives (HDD), Storage Area Networks (SAN) and Network Attached Storages (NAS), and computer networks such as LAN, enterprise networks and the Internet provide us with unprecedented capacity to store, access, and process an enormous amount of information. Such capacity has the potential to tremendously expand both the breadth and depth of individual users' knowledge and intellectual capacity, and revolutionize their productivity and creativity by enabling them to see and make use of the right information at the right time. However, this has not happened due to the deficiencies of today's computer systems and network software, and information retrieval, management and access methods. Such deficiencies can be summarized as inadequate and antiquated information retrieval and management systems, inefficient and manual search processes, and a general lack of intelligent assistance to human users. There are four vastly underutilized resources today: (1) the processing power of high speed processors, at multiple GHz today and expected to continue to increase from both processor technology and architectural innovations; (2) the large amount of local storage on a computer and on a network; (3) the increasing network connection bandwidth; and (4) the huge and ever increasing amount of information accessible over the Internet, including the interactions of many millions of users' with the information on the Internet. Multi-GHz fast processors are idle for a lot of time, and many are turned off after work. Current Internet search engines perform searches for keyword matches, and categorize search results into a limited number of categories such as web pages, groups, directories, images, and news. All web pages are listed together and are ranked by a ranking formula that is kept secret by the search engine provider. The ranking formula is subject to manipulation by vendors and search engine optimization service providers. Users are forced to accept such a secret formula ranking, with the manipulations by various web sites trying to push them to the top ranks. It is difficult for a user to find what he is looking for if it is not given a high ranking by the search engine.

Prior art search engines present search results to a user with little organization, in a linear order dictated by the search engine provider using a secret formula. The search results are classified into a handful of categories of “Web Pages”, “Directory”, “Groups”, “Images”, and “News”. In many cases, most of the search results are listed in the “Web Pages” category. It may include hundreds or thousands or more pages. Unless what the user is looking for happens to be what the search engine ranks on the first few pages of search results, it is very much like searching a needle in a haystack for a user to find what he is looking for, and as a result, the user most likely will not see it. There are prior art search engines that provide specialized search services, such as yellow page search, shopping search, image search, travel search, etc. A user needs to select the specialized search before the search and only specialized results are returned. Such prior art specialize search engines are commercialized, using specialized databases that typically require payment for inclusion.

Some prior art search engine asks a user questions in order to better define a search. For example, if a user types in a web URL, e.g., search.com, in the Google search box, Google asks the user to select from a list of options:
Google can show you the following information for this URL:
Show Google's cache of search.com
Find web pages that are similar to search.com
Find web pages that link to search.com
Find web pages that contain the term “search.com”
   After the user makes the selection, Google proceeds with the refined search and presents the results, with little organization as described above.

One specific advanced search algorithm uses a pre-coded lexicon that defines elements of a semantic space, and specifies relationships between such elements to represent relationships among concepts. In order to retrieve information based on concepts, it defines a semantic distance as the number, type, and directionality of links from a first concept to a second concept to represent the closeness in meaning between said first concept and said second concept. However, this algorithm does not address the deficiencies identified above. Search results presented in search engine fixed and limited categories, search results presented in search engine dictated ranking, and keywords search that retrieves many results unrelated to users intention.

An example of personalization of search using a user's history is that if a person owns a Jaguar car and searches the keyword “Jaguar”, the search engine should return results related to the automobile or rank the such results higher, not return results on the animal jaguar or ranked them much lower if such results are returned. Such a personalization approach has two problems. First, it requires collecting personal information that presents privacy concerns to many users. Second, the search engine does not really know what the user is searching for. It may well be that a Jaguar automobile owner owns of car of the brand because he is fond of jaguar the animal, thus, he may sometimes want to search for information on the animal and sometimes for information on the automobile. If the search engine guesses wrong or excludes websites or pages, the user experience will be unsatisfactory. Other approaches guess what a user is looking for based on the input the user types in the search box, and present the matching results to the top of the search results display. AskJeeve is such an example.

Today's search engines require a user to type in various keywords and combinations manually, scan and scroll through search results item by item and page by page, and wait for downloads. This significantly limits a user's productivity and the amount of information he is able to sift through. For the most part, a user is able to access only a small fraction of the massive amounts of information on local storages and over the Internet, because prior art programs and usage models require a user to actually type or click in front a computer to access information. Thus, the amount of information, especially unstructured information, which accounts for a large part of the available information, that can be accessed by a person is limited by his time and processing bandwidth. The ratio of the amount of information that can be of use to a person vs. the amount of information the person can actually access is a huge number and will continue to increase rapidly. Broadband connections to the Internet are becoming prevalent and the bandwidth available to businesses and home users will continue to increase. However, during much of the time, the bandwidth is not utilized unless the user is downloading large files or watching video. Such available resources should be put to better use, rather than being left idle or underutilized.

Today's computer file systems are still based on the same old concept as physical file cabinets and file folders. It is often very difficult for a user to find a file if he forgets exactly which folder it is in, or the file name, or exact keywords used in the file. Even if a user remembers some exact keywords used in a file, searching files on a computer with a large disk takes a lot of time.

Computer file systems such as those in Microsoft Windows OS, Apple's Mac OS, and Linux OS are still based on the same old concept of physical file cabinets and file folders. In the case of file cabinets and folders, each folder and file can only physically be in one location. However, this limitation is no longer present on a computer. A file or folder may physically be located in one part of a disk, but it may logically be present in more than one categories or lists or nodes in a hierarchy. Prior art file systems do not make use of this fact to improve the organization of files on a computer. As disk sizes increase and more information becomes available over the Internet, a user may have many files spread over many folders and subfolders, and may browse over many web pages. As a result, it is often difficult to find a file or a web page if the user does not remember the exactly location or exact keywords used to search for the file or page. For example, there is no effective methods in prior arts for finding a file one worked on two months or two years ago, that has something to do a certain topic, or contains a certain concept or quote. If a user knows some exact keywords used in a file, the user can search for it using the “Search” window on prior art operating systems. However, this search can take a long time for a large disk, during which time, the computer's CPU and disk are busy and have little resources left to do other tasks.

There are search programs for personal computers, e.g., Idealab's X1 searcher, that build an index of files and emails to speed up the search of files and emails on a computer. However, it is still a keyword search program. It simply returns matching emails or files in a linear list, does not provide any other structure or organization to search results, and is not to be used as an organized file system. It's searches are based on keyword matches. If a user does not remember the keywords, it is of no help to him. If he uses too few keywords, too many results may be returned in the list, without any structure or organization, making it difficult to find the file he wants. If he uses too many keywords, the file he is searching for may be excluded.

There are prior art solutions for enterprises that organize files with a categorization hierarchy such as those by Autonomy Corp., Documentum division of EMC Corp., Inxight Software Inc., and Clearforest Corp. Such prior art categorizations are typically limited to categorization by the keywords extracted from the documents. In order to locate a file, a user needs to know the category to which a document should belong in order to navigate through the categorization hierarchy. But often users only have a vague memory of what a file is about, and even if a category is identified, there may be too many files in the category. A user may need to open up the files one by one to find what he is looking for.

In both Internet searches and on-computer file searches, if too few keywords are used, too many results may be returned. If too many keywords are used, desired results may be ruled out. The challenge is that a user has access to a tremendous amount of information, but it takes too much time to find the right information and to read the information.

None of the above mentioned prior arts solves the deficiencies identified in this patent application. Therefore, from the foregoing, it becomes apparent that there is a need in the art for the development of advanced methods for intelligent file and web searching, for computer file management, and for providing intelligent automated assistance to users to effectively retrieve, discover, monitor and use files and information.

### BRIEF DESCRIPTION OF THE DRAWINGS

FIG. 1 is a block diagram illustrating an exemplary computer system upon which embodiments of the present invention may be implemented.

FIG. 2 is a block diagram illustrating components of an advanced search system according to one embodiment of the present invention.

FIG. 3 illustrates an exemplary user interface for presenting categorization of search results where the categories are dependent of the keywords used in the search according to one embodiment of the present invention.

FIG. 4 shows an example of a user interface for accepting a user's input of search objective and descriptive advice according to one embodiment of the present invention.

FIG. 5 is a block diagram illustrating components for performing an advanced web search with processing, categorization and ranking run on a user's local computer according to one embodiment of the present invention.

FIG. 6 is a block diagram illustrating components of a file-based search program according to one embodiment of the present invention.

FIG. 7 is a block diagram illustrating components of a file organization program according to one embodiment of the present invention.

FIG. 8 shows an example of a user interface window of a file organization system according to one embodiment of the present invention.

FIG. 9 shows an example of a user interface of a file organization system for finding files by keywords or concepts or description according to one embodiment of the present invention.

FIG. 10 shows an example of a user interface window through which a file may be selected and files related to the selected file may be shown according to one embodiment of the present invention.

FIG. 11 is a block diagram illustrating components of an intelligent assistant agent according to one embodiment of the present invention.

FIG. 12 is an example of a knowledge representation that can be used by various embodiments of the present invention.

FIG. 13 is a block diagram illustrating a client-server model implementing embodiments of the present invention.

FIG. 14 is a flowchart illustrating keyword dependent categorization according to one embodiment of the present invention.

FIG. 15 is a flowchart illustrating user-selectable, multidimensional, and category specific ranking according to one embodiment of the present invention.

FIG. 16 is a flowchart illustrating determining a user's search intentions according to one embodiment of the present invention.

FIG. 17 is a flowchart illustrating a file-based search according to one embodiment of the present invention.

FIG. 18 is a flowchart illustrating a high level semantic search using predicates or propositions according to one embodiment of the present invention.

FIG. 19 is a flowchart illustrating a relational organization of files according to one embodiment of the present invention.

FIG. 20 is a flowchart illustrating a use of list of links to to search for information according to one embodiment of the present invention.

FIG. 21 is a flowchart illustrating advanced file system organization according to one embodiment of the present invention.

FIG. 22 is a flowchart illustrating processing of an active intelligent file organization according to one embodiment of the present invention.

FIG. 23 is a flowchart illustrating an automated association process according to one embodiment of the present invention.

### DETAILED DESCRIPTION OF THE PRESENT INVENTION

Reference will now be made to the drawings wherein like numerals refer to like parts throughout. Exemplary embodiments of the invention will now be described. The exemplary embodiments are provided to illustrate aspects of the invention and should not be construed as limiting the scope of the invention. When the exemplary embodiments are described with reference to block diagrams or flowcharts, each block represents both a method step and an apparatus element for performing the method step. Depending upon the implementation, the corresponding apparatus element may be configured in hardware, software, firmware or combinations thereof.

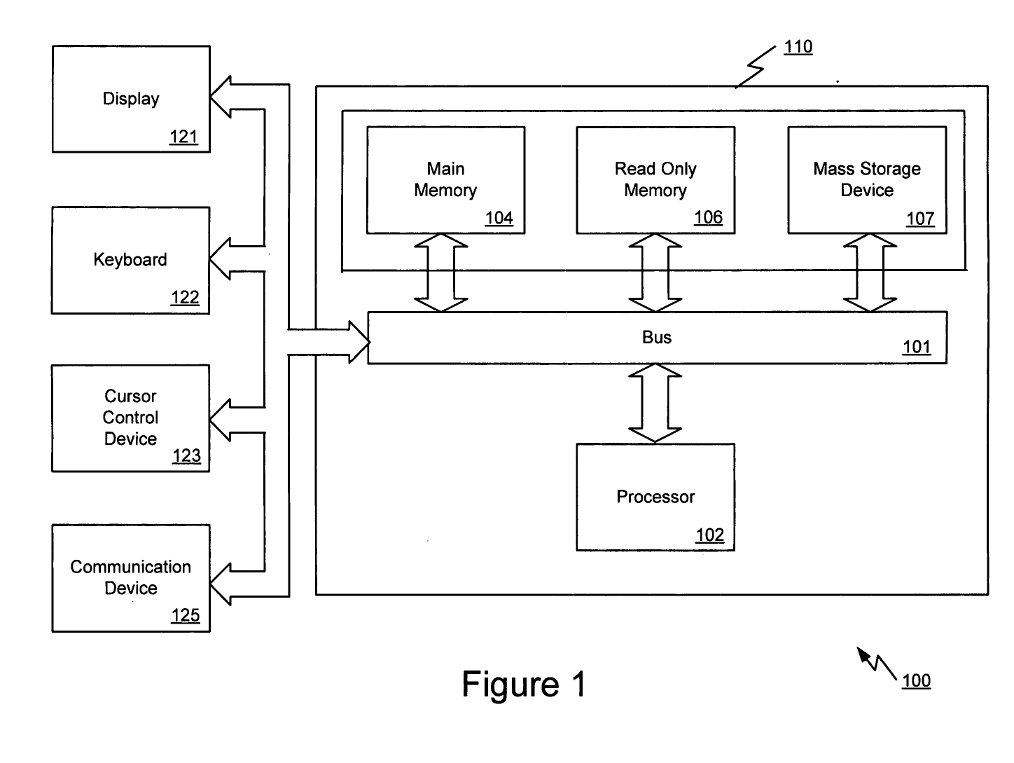

FIG. 1 is a block diagram illustrating an exemplary computer system upon which embodiments of the present invention may be implemented. In its most basic configuration, system 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by line 106. Additionally, system 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 100. Any such computer storage media may be part of system 100.

System 100 typically includes communications connection(s) 112 that allow the system to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 100 may also have input device(s) 114 such as keyboard, mouse, pen, voice input device, touch input device, etc. Output device(s) 116 such as a display, speakers, printer, etc. may also be included. All these devices are well know in the art and need not be discussed at length here.

Embodiments of the present invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

### Advanced Web Searches

Keywords Dependent Categorization

Presented herein are search methods and systems that overcome the above problems and limitations. The various embodiments of the present invention avoid the problems of wrong guesses of user's intent and exclusions caused thereby, do not require a user's history or private information, and do not require specialized databases of web content. Embodiments of the present invention use the billions of web pages that are openly available on the Internet. In one embodiment, a search engine searches all results related to the keywords provided by a user and presents the search results in categories that are specific to the search keywords. An example is a keyword search of “Jaguar”. The search engine retrieves all available results related to the keyword, including information on jaguar the animal, the automobile, sports teams and mascots so named, etc. Categories for the keyword include: Jaguar automobiles with subcategories of reviews, dealer and prices, services and help resources etc.; the animal jaguar with subcategories of zoological information, habitat and ecosystem, protection and natural preserves etc.; sports teams; books with subcategories; news with subcategories and so on. Another example is a search for the keywords “wireless networking security.” The categories for such keywords include technology with subcategories of research, books, white papers, conferences, research organization, industry standards, news etc.; manufacturers with subcategories of IC chip makers, software vendors, system integrators, equipment vendors, news etc.; products with subcategories of enterprise products, home products, reviews, technical support, software download, retailers, recalls, reviews and comparisons, news etc. Another example is a search using the keyword “turkey.” The search may return results about Turkey the country, turkey the poultry, or Turkey the poultry in Turkey the country. These results are best handled by categorization rather than guessing what the user really means.

The categorization for a keyword or a set of keywords is also time-dependent, especially for current events. An example is a search for keywords Israel Palestine peace and conflicts, in the year of 3003. The categories for such keywords include: history with subcategories of Israel history, Palestine history, political leaders, military conflicts, past peach efforts etc.; and more time-dependent categories of current governments and political leaders with subcategories for Palestine and Israel; the US roadmap with subcategories for US position, international activities, positions of Arab countries, Israeli position, Palestinian position etc.; news with subcategories of suicide bombing, Israel military actions, Arab news, Israeli news, Western news etc. Such keyword dependent categorization organizes the search results in a convenient, easy to understand, and easy to access structure that allows a user to quickly identify the information for which he is searching.

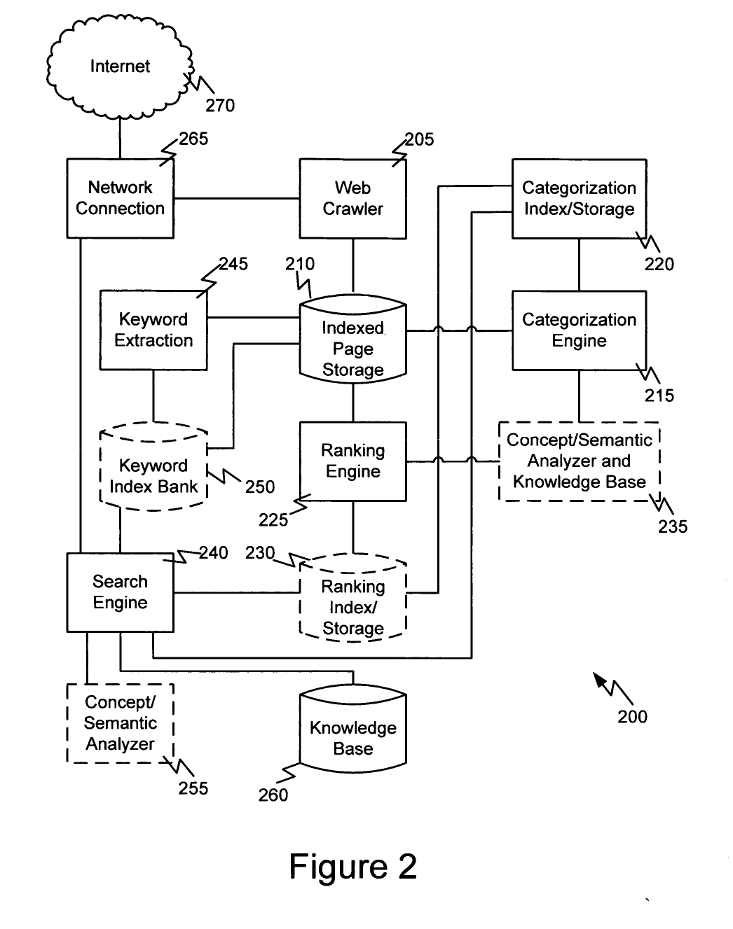

To present the search results to the users quickly with keyword dependent categorization, a search engine according to one embodiment of the present invention pre-categorizes indexed pages based on keywords or concepts. FIG. 2 is a block diagram illustrating components of an advanced search program according to one embodiment of the present invention. A web crawler 205 searches the Internet 270 and collects indexed web pages or documents, hereafter all referred to as indexed pages, into an indexed page storage 210.

A categorization engine 215 categorizes the indexed pages into a hierarchy of categories and subcategories, and generates category and subcategory names. The categorization hierarchy can be deeper than two levels with sub-subcategories, and so on, and a subcategory can belong to more than one upper-level categories. The categorization results can be either written into the indexed pages storage 210 as new categorization fields in the entry for each indexed page, or written into a categorization index/storage 220. Each indexed page can belong to multiple categories or subcategories. New categorization methods using concept or proposition space described below, or other, known categorization methods such as latent semantic analysis, keywords clustering, human annotated categorization, ontologies, or a combination of methods can be used to categorize the indexed pages and the category names. The categorization index/storage 220 can be indexed by category or subcategory names, or by indexed pages. In the former case, each entry in the categorization index/storage 220 is a category or subcategory name and has fields containing the keyword(s) or concept(s) it is associated with, its parent and child categories, and a list of indexed pages that belongs directly to this category or subcategory level. If a category or subcategory is an end node in the categorization hierarchy, each entry is a category or subcategory name and has fields containing the keyword(s) or concept(s) it is associated with and a list of indexed pages that belongs to the category or subcategory. In the latter case, each entry contains a pointer or a link to an index page, the names and the associated the keyword(s) or concept(s) of the category and subcategory (or categories and subcategories) the indexed page belongs to, and the parent and child categories or subcategories.

If the categorization results are stored in the indexed pages storage 210, the categorization results may be stored in several different forms. In a first case, a separate file is stored that contains an entry for each indexed page contains a pointer or a link to an index page, the names and the associated the keyword(s) or concept(s) of the category and subcategory (or categories and subcategories) the indexed page belongs to, and the parent and child categories or subcategories. In a second case, all category or subcategory names are recorded as nodes in a categorization hierarchy that is stored in a separate file, and link(s) are inserted in an index page for each keyword or keyword combination that is used in the categorization. Each link points to a category or subcategory node to which the keyword or keyword combination is categorized. If a keyword or keyword combination is associated with multiple categories or subcategories, multiple links will be inserted for such a keyword or keyword combination.

The pre-categorization process makes categorization of search results quickly available. The categorization hierarchy is built using web pages that are available on the Internet, and does not require a specialized database as in other specialized search engines, e.g., hotel and travel search engines.

An optional concept/semantic analyzer and knowledge base 235 works with the categorization engine 215 to achieve a level of conceptual and semantic understanding in the categorization so that the categorization is done by concepts or semantics rather than by keywords, and the context is taken into consideration in the categorization. For example, the concept and semantic analyzer and knowledge base 235 may have the knowledge to categorize keywords such as car, automobile, truck, motorcycle under the category of motor vehicles, and may be able to look at the context of the keywords such as Jaguar and Explorer and categorize a corresponding indexed page into the category of automobile and subcategories of passenger cars and SUV, and into the category of Jaguar Cars and Ford Motor Company under automobile manufacturers.

Category and subcategory names can be generated by picking the most frequent or most important (e.g., in title, or abstract, or conclusion, or by semantic analysis) word or words in the indexed pages in the category or subcategory. Category and subcategory names can also be generated using concept extractions or abstractions to move higher in a categorization hierarchy. Ontologies may be used in generation of category and subcategory names. To ensure the quality of the categorization results and category and subcategory names, they may be manually edited. In one embodiment, top level category and category names are manually edited, since the number of categories at the top level is manageable by manual editing, e.g., toys, automobiles, retailers, manufacturers, universities, research, product reviews, software, etc. Then, the automatically generated categories can be classified as one of the manually edited categories or as a subcategory in one or more of the manually edited categories.

A search engine 240 accepts search requests from users. An optional concept/semantic analyzer 255 is used to achieve a level of conceptual and semantic understanding of the search request so that the search is done by concepts or semantics rather than by exact keyword matches, and the context of the request is taken into consideration in the categorization. The concept/semantic analyzer 255 may function in two phases. In a search pre-processing phase, it generates conceptually equivalent keywords, different combinations of keywords etc. to cover what the user may be looking for. For example, if a user searches for keywords “Jaguar car repair”, the concept/semantic analyzer 255 generates additional keywords “automobile”, “service”, and combinations such as “Jaguar car service”, “Jaguar automobile repair”, and “Jaguar automobile service”. In a post-processing phase, the concept/semantic analyzer 255 may use the context of the keyword search to filter the retrieved results. For example, in the above example, the concept/semantic analyzer 255 may filter out a page that contains a story about a jaguar in a zoo, and an alert of a recall for Ford cars that need repair services.

To speed up the search, most frequently used keywords or keyword phrases, hereafter all referred to as keywords, can be extracted by a keyword extraction engine 245 and saved in a keywords index bank 250. Each keyword or keyword phrase entry in the keywords index bank 250 includes a list of the indexed pages that contain the keywords. Logs of keywords used by users can be used to update keywords in the keywords index bank 250 to keep it current with keywords that have the highest probability of being used in searches. The keywords index bank 255 serves as a cache so that indexed pages can be retrieved faster. The use of the keyword index bank can be optional.

The search engine 240 searches the indexed pages using the analysis provided by the concept/semantic analyzer 255 and the keywords index bank 250. After the search is complete, the search engine 240 presents the categories and subcategories that the matched pages belong to, as is shown in FIG. 2. Although the categorization hierarchy may have many levels, in one embodiment, the search results are organized into two levels of categorization to avoid requiring users to spend too much time navigating the categorization hierarchy. Depending on the keywords used in a search, search results may be from any level of the categorization hierarchy. For example, if a user searches keywords “wireless networking”, the top level categories of the search results will include WLAN (wireless local area networking), WPAN (wireless personal area networking), WMAN (wireless metro area networking), Cellular Network, etc., each of them showing another level of subcategories. On the other hand, if a user searches for more narrowly defined keywords “802.11b WLAN”, the top level categories of the search results may be technology, manufacturer, retailer, service provider, etc., while some of them show a level of subcategories and others have no subcategories.

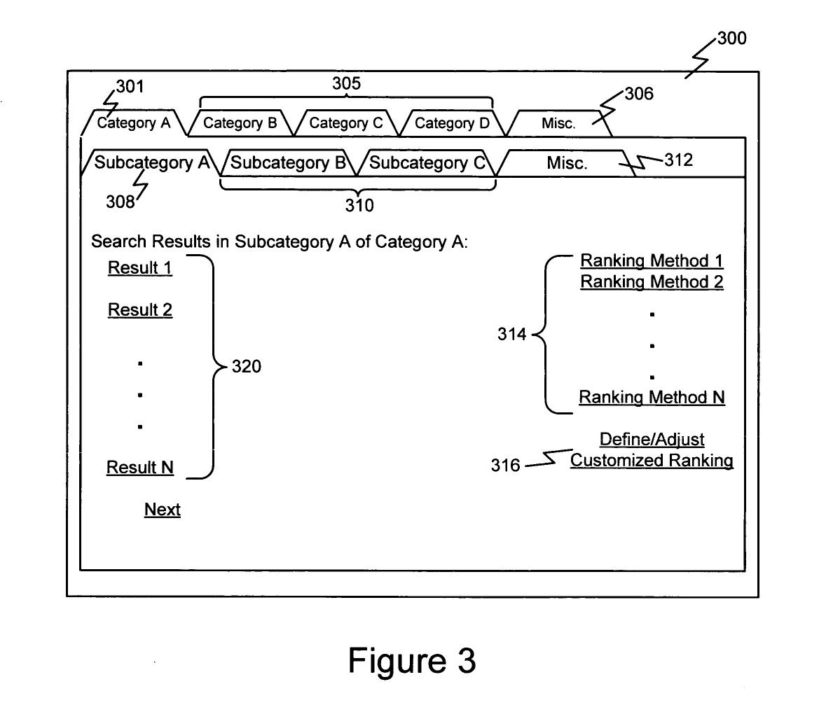

The matched pages in a category or subcategory with the highest number of pages or highest ranking based on keywords or concept matches may be displayed as a default. Other categories and subcategories may be displayed as index tabs. FIG. 3 illustrates an exemplary user interface for presenting categorization of search results where the categories are dependent of the keywords used in the search according to one embodiment of the present invention. In FIG. 3, subcategory A 308 of category A has the highest number of pages or highest ranking based on keywords or concept matches, and the titles and summaries of these pages 320 in this subcategory 308 can be displayed. The other categories 305 and 306 and other subcategories of category A 310 and 312 can be displayed as index tabs. When the user clicks on a category tab, pages in that category and/or its subcategories can be displayed. Similarly, a subcategory with the highest number of pages or highest ranking based on keywords or concept matches may be displayed as a default when the index tab for the category is clicked. If there are too many categories and subcategories to display, only the names of the first several categories and/or subcategories that have the highest numbers of pages and/or best matches can be displayed. The rest of the search results can be listed under an index tab “Miscellaneous” 306 and 312 as shown in FIG. 3. When the user clicks on this tab, the categories and/or subcategories and/or pages that may be grouped under this tab can be displayed in the same manner as the methods described above. Note that an indexed page may be displayed in multiple categories/subcategories with category-specific rankings. Rankings in this invention may be category-specific and can be pre-calculated or partially pre-calculated to allow users to select ranking methods, as discussed below.

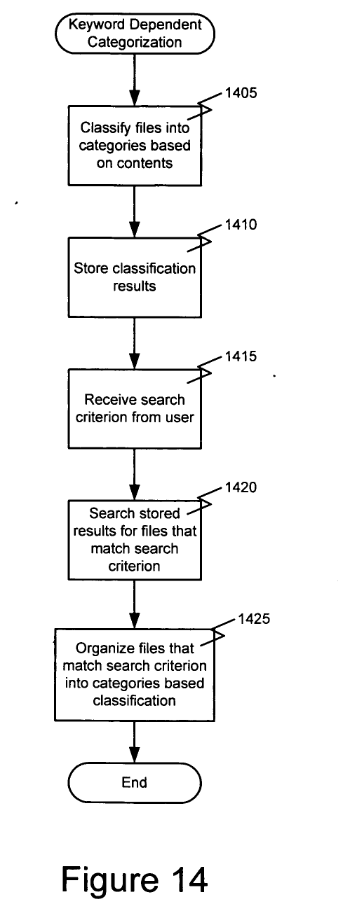

FIG. 14 is a flowchart illustrating keyword dependent categorization according to one embodiment of the present invention. In this example, processing begins with classification operation 1405. Classification operation 1405 comprises classifying one or more files stored in one or more storage devices into categories based on contents of the one or more files. As noted above, classifying files stored in one or more storage devices into categories can further comprise classifying the files into a hierarchy of categories and subcategories and generating a name for each category based on analysis of the contents of the files classified into each category.

Processing then passes to store operation 1410. Store operation 1410 comprises storing results of classifying the one or more files. Then, at receive operation 1415, a first search criterion is received from a user. Control then passes to search operation 1420.

Search operation 1420 comprises searching the stored, classified results for one or more files that match the first search criterion. Then, at organization operation 1425, the one or more files matching the first search criterion are organized into a first set of categories that is a collection of the categories into which the one or more files that match the first search criterion are classified. Organizing the one or more files matching the first search criterion into the first set of categories can be performed on a processing device operated by the user. A processing device can comprise a personal computer (PC), computer, server, client, client terminal, set top box, automatic controller, mobile phone or handset, PDA, network processor, router, Web Service server, Media Center PC, network attached storage, storage network controller, or any other device capable of processing and/or storing information. Additionally, organizing the one or more files matching the first search criterion into a first set of categories further comprises ranking the first set of categories using a ranking formula based on one or more ranking criteria. Embodiments providing such ranking my also provide a user interface to allow the user to change the ranking criteria or ranking formula. Such a user interface may further display names of or links to the first set of categories, and names of or links to files in a highest ranked category as a default.

According to one embodiment of the present invention, categorization can also comprise displaying the names of or links to the first set of categories. In response to the user selecting more than one category, the names of or links to the files that are present in all selected categories can be displayed.

User Selectable Multidimensional and Category-Specific Ranking

Embodiments of the present invention create a democratic web and individualized ranking of search results fitting users' needs by allowing a user to choose how he wants to rank the search results, or choose a ranking method and adjust its parameters. This allows personalizing and individualizing the ranking of search results to each user and each search, not forcing a ranking dictated by a search engine company onto users, as the prior art search engines do.

Search results can be ranked on multiple dimensions. Some examples of ranking dimensions are link popularity, visit popularity, conceptual match, exact keywords match, amount of information on the topic (measured on multiple dimensions, for example, number of paragraphs or words that are related to the keywords or the concepts expressed by the keywords), author and site authority and objectivity (measured on multiple dimensions, for example, from a top ranked university or research lab, an recognized expert, objective research vs. commercial), nature and objective of information (measured on multiple dimensions, for example, news, political, educational, technical, commercial, retail, promotional, etc.), and so on. Referring back to FIG. 2, in one embodiment, the pages in the indexed page storage 210 are pre-ranked by a ranking engine 225. That is, each indexed page is assigned a ranking, e.g., on a scale from 0 to 10, on each of a set of ranking dimensions. The ranking engine 225 can improve the rankings results by working in conjunction with the concept/semantic analyzer 235. The concept/semantic analyzer 235 enables the ranking along some dimensions to be done with concepts and semantics rather than keywords matches. Similar to the categorization results, rankings of each indexed page are either written back into the entry of the indexed page in the indexed page storage 210 as additional ranking fields, or into a separate ranking index/storage 230. The ranking of search results are produced by a ranking formula that combines some or all of the ranking dimensions by assigning each dimension a weight parameter. An example formula for the ranking R(pⱼ) of a page pⱼ is given below:

$$R ( {p}_{j} ) = {\sum }_{i}^{N} {w}_{i} {r}_{i} ( {p}_{j} ) = w \cdot {r}^{t} ( {p}_{j} ) \qquad ( 1 )$$

where wᵢ is the weight for ranking rᵢ(pⱼ) of page pⱼ on ranking dimension i, and w and r(pⱼ) are the corresponding weighting and ranking vectors. Note that to ignore a dimension in the ranking, one simply sets the corresponding weighting on the dimension to zero. If a ranking is to be done with only one ranking dimension, then weight is nonzero only on the ranking dimension of interest, and zero for all other dimensions.

After the search engine 240 retrieves the search results, according to one embodiment, a default ranking method, using one or more ranking dimensions according to a default ranking formula, is used to rank and present the search results to the user such as in results list 320 in user interface 300 of FIG. 3. The user can then click on a different ranking method shown in the ranking method list 314, and the updated search results can be displayed in results list 320 and ranked according to the ranking method chosen by the user. The list of ranking methods 314 may also include custom defined ranking methods that are defined by the user. The user may click the “define/adjust custom ranking” link 316 which takes the user to a screen that allows the user to pick and adjust the weight of each ranking dimension used in the custom ranking method. For example, a research student or design engineer can assign higher weight to the dimension of technical and educational nature of the information so that educational sites and technical publications will be ranked higher, while a consumer may assign higher weight to the dimension of retail nature of the information so that retailer sites, price comparisons and product reviews will be ranked higher. After the user submits the new weighting vector w of the ranking dimensions, the search engine 240 computes the new ranking order of the search results in a category or subcategory using a formula similar to equation (1). Since the vectors r(pⱼ) have been pre-computed for all pages in the search results, this re-ranking computation is quick and can be done in real time at search time. This way, rather than scrolling over page after page, a user can simply select or adjust the different ranking options, to increase the probability that what he is looking for will appear as top ranked pages. Once a user selects a default ranking method, it can remain the default until the user changes it.

In the display of search results, the ranking of an indexed page is different for each category or subcategory because different pages may be contained in the search results of each category or subcategory. In addition, within different category or subcategory, the indexed pages may have been retrieved with different components or combinations or concepts or the same page may be contained in multiple categories but with different rankings. As a result, an indexed page may rank high in one category or subcategory, but may not be present in another category or subcategory, or may be present but with a much lower ranking.

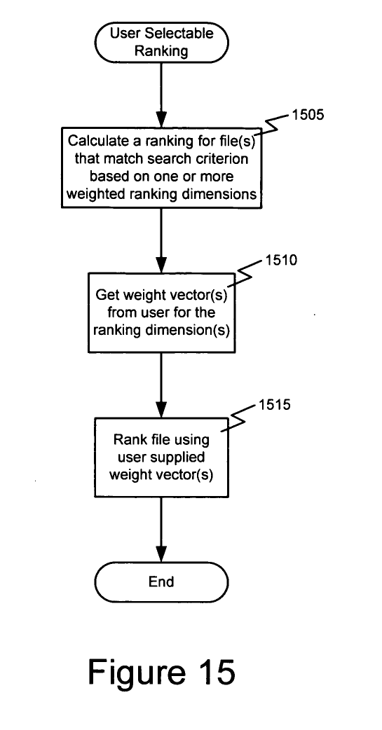

FIG. 15 is a flowchart illustrating an example of user-selectable, multidimensional, and category specific ranking according to one embodiment of the present invention. Here, processing begins with calculation operation 1505. Calculation operation 1505 comprises calculating a ranking of a file in a set of files that match a search criterion in one or more weighted ranking dimensions. Control then passes to input operation 1510.

Input operation 1510 comprises receiving from the user one or more weight vectors for the ranking dimensions. Input operation 1510 can comprise providing a user interface to allow a user to select a weight vector for the one or more weighted ranking dimensions. According to one embodiment of the present invention, input operation 1510 can further comprise providing a user interface to allow the user to define a new ranking dimension. Such a user interface may also provide more than one pre-defined weight vectors for the user to select or allow the user to combine two or more pre-defined weight vectors to create a new weight vector.

Finally, at ranking operation 1515, the set of files can be ranked by applying the weight vector selected by the user. According to one embodiment of the present invention, ranking the set of files using the weight vector selected by the user is carried out on a processing device operated by the user.

User Objective and Detailed Description Options

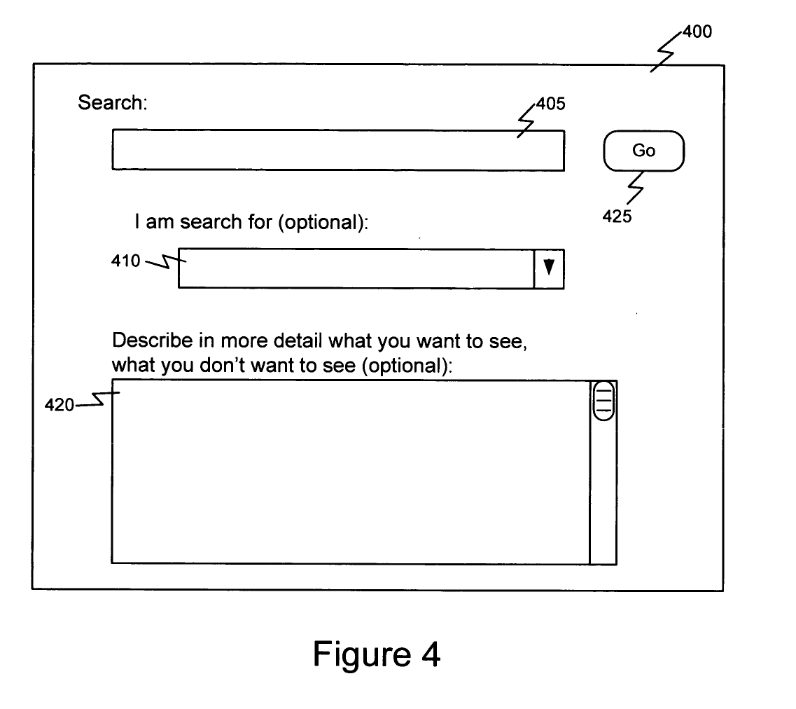

Embodiments of the present invention include a new search interface and accepts user advice to better define what he is looking for. One embodiment of the new search interface is shown in FIG. 4. According to this embodiment, there are two optional input areas, an objectives area 410, and an advice area 420. A user may type in keywords to be searched in 405. He may go ahead with the search using only the keywords by clicking the “Go” button 425. To better define a search, a user can use the objectives area 410 to inform the search engine of the objective of his search. In one embodiment, the objective area 410 is a pull-down menu with listings such as Shopping-Retail, Educational Information, Legal Information, Sell, Research, Market Study, Discussion, Collect Information of an Organization or Individual, and so on. Alternatively, a user may type in what his search objective is. In another embodiment, the objectives are listed as check boxes, and a user may choose one or more objectives by clicking the check box. In the user advice area 420, a user may state in free form text input in more detail what he is looking for and/or what he is not looking for. For example, “I prefer a good brand name”, “HP is first choice, Gateway is second choice”, or “low price is most important”. Note that these are not search keywords, but advice or guidance in selecting search results.

To speed up the search time, indexed pages can be pre-classified into the different search objective categories listed in the pull-down menu or check boxes in area 410. This way, at search time, indexed pages with a classification matching a user's objective will be searched. For example, if a user specifies his search objective as shopping, indexed pages that are classified into the shopping objective category are searched. If a user specifies his search objective as learning, indexed pages that are classified as educational or learning objective category will be searched.

Referring to FIGS. 2 and 4, when a user clicks the “Go” button 425, the search interface submits the keywords, the objective, and user advice, if they are provided by the user, to the search engine 240. The search engine 240 sends the search keywords typed in area 405, together with the user objective(s) selected or typed in area 410 and user advice typed in area 420, to the concept/semantic analyzer 255 which generates keyword strings to search for. Note that the search keyword strings generated by concept/semantic analyzer 255 may be different than the ones entered by the user. In general, concept/semantic analyzer 255 may broaden the search to include searches using more keywords or combinations, and/or may narrow some of the keyword searches. The result is searches that can better reflect the user's search objective in objective area 410 and advice in advice area 420. When search results are generated with the search keyword strings, the search engine 240 again calls the concept/semantic analyzer 255 to filter and rank the search results. The concept/semantic analyzer 255 filters and ranks the search results using the concept matches and context of the keywords in the web pages, and using the information in the objectives area 410 and advice area 420. The search engine 240 ranks the search results using the concept matches and context in the keywords, analysis of user inputs in the objectives area 410 and advice area 420, and pre-computed rankings r(pⱼ). For example, if a user inputs in the objectives area 410 that his objective is to buy from an online retailer, then, categories and pages from online retailer sites, product reviews and price comparison sites can be given higher rank, and categories and pages from research organizations, universities, industry standards, etc. can be excluded or ranked lower. If a user selects technology research as his objective, then, categories and pages from research organizations, universities, industry standards will be given higher rank, and retailers, price comparisons etc., can be given lower rank or eliminated from the search results. If a user search for keywords “WLAN products”, and input his objective as market intelligence, the search engine may rank search results in the following order: web pages about the competitors in the market segment; comparison of their products; their market shares, prices, patents, and technology, etc.; and then, retailers who carry these products.

If a user inputs in the advice area 420 that he prefers good brand names, then the search results of products can be ranked by the popular reputation of brand names. The search engine 240 computes the ranking of search results based on the analysis of the user's advice and objectives provided by the concept/semantic analyzer 255, the pre-computed ranking r(pⱼ) and information provided by an optional knowledge base 260. The knowledge base 260 contains common knowledge and information useful for customized ranking of search results based user advice and objectives, such as list of manufacturers of various products, providers of various services, reputation rankings of brand names, ranking of universities, customer service satisfaction levels of companies, names of experts and authorities on various subjects, etc. The knowledge base 260 may be created by expert inputs or by collecting, analyzing and categorizing information over the Internet.

The search engine 240 presents the filtered, categorized and ranked search results to the user. If a user selects more than one objective, e.g., in the case search objectives are listed as check boxes and the user checked more than one box, the search results are categorized according to the different objectives, e.g., a shopping category, and a technology learning category if the user selects two objectives: shopping, and technology learning.

The difference between search keywords and user's objectives and advice is that the words used to describe user's objectives and advice may or may not be in the pages. User's advice can either expand or limit the scope of the keyword search. User's objectives help define the scope of the categorization and nature of the sites, e.g., an online retailer, manufacturer, research organization, government, standards organization, etc., and can be used in ranking the search results so that pages better matching the user's objectives are ranked higher. User's advice is used in generating keywords and concepts used in searching the indexed pages, and in ranking and filtering the search results so that a manageable number of pages that have high probability to match what the user is looking for are presented to the user. This is in contrast to other search engines that present a user with thousands to tens of thousands of pages with a ranking dictated by the search engine. When a search returns that many pages, most users do not look through more than the first 20 to 30 pages. If what the user is looking is not found in these first 20 to 30 pages, the search results are abandoned.

Therefore, keyword dependent categorization according to embodiments of the present invention allows the capture of potential intentions of a user without overwhelming the user with too many irrelevant results because he can choose the category he is looking for and ignore the other categories retrieved from the other meanings of the search string. User selectable and adjustable multidimensional ranking according to embodiments of the present invention allows a user to find what he is looking for faster, and puts the control of ranking of search results into the hands of the user, not the search engine company. Using user's objective and advice in a search allow more accurate search and ranking matching the user's search objectives. Integration of these embodiments creates a more useful, efficient, effective, user friendly, and democratic search engine.

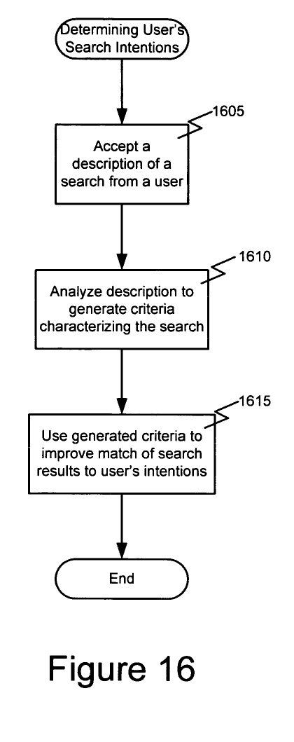

FIG. 16 is a flowchart summarizes determining a user's search intentions, namely search objectives or preferences, according to one embodiment of the present invention. In this example, processing begins with input operation 1605. Input operation 1605 comprises accepting a description of a search provided by a user. The description of the search provided by the user is one or more keywords, a combination of one or more keywords and a description of the user's search objective, a natural language description of what the user wants to search, or a combination of one or more keywords and a description that further defines the user's preference for the search. According to one embodiment of the present invention, a list of search objectives may be provided and the user provides a description of his search objective by selecting one or more items in the list of search objectives. According to another embodiment of the present invention, when the user selects more than one item from the list of search objectives, the search results can be categorized into each of the selected search objectives.

Control then passes to analysis operation 1610. Analysis operation 1610 comprises analyzing the description to generate one or more criteria to characterize the search. Generating one or more criteria from the user's description can comprise generating one or more additional keywords conceptually related to the one or more keywords provided by the user and using the one or more generated keywords to perform the search.

Finally, at matching operation 1615, the one or more generated criteria can be used to improve a match of results of the search to the user's intention. For example, the one or more keywords provided by the user and the one or more generated additional keywords can be used to perform the search to improve the match of the search results to the user's intention. Additionally, the one or more criteria generated from the description of the user's search objective can be used to filter or rank the files in the search results that contain the one or more keywords provided by the user. According to one embodiment of the present invention, the one or more criteria generated from the description that further defines the user's preference for the search can be used to filter or rank the files in the search results that contain the one or more keywords provided by the user.

Intelligent Expanded Web Search and File-Based Search

Advanced Web Search Assisted by Local Processing

According to another embodiment of the present invention, the categorization, user selectable ranking, and user objective analysis are performed on a user's computer locally so that the advanced search functions can be achieved using results gathered from available Internet search engines. In this embodiment, a user types keywords in a search box in a user interface 510 as shown in FIG. 4. The user interface 510 sends the keywords to a concept and semantic analyzer 520 on the user's computer for analysis, which sends the analysis results to a search query generator 530 on the user's computer that generates keywords and keywords combinations to capture the various concepts that are represented by the keywords the user provided. A search engine interface 540 submits the keywords and keywords combinations generated by the search query generator 530 to one or more search engines over the Internet 545.

When the search engine(s) returns the search results, they are accumulated in a buffer 550. A semantic filter 560 filters the search results based on the concepts and semantic meanings of the search keywords provided by concept and semantic analyzer 520. The search results that remain after passing through the semantic filter 560 are categorized and ranked by a categorizer and ranker 570 along with one or more ranking methods, e.g., link popularity, visit popularity, conceptual match, exact keywords match, amount of information on the topic, author and site authority and objectivity, nature and objective of information, etc. The categorized and ranked results are presented to the user via the user interface 510. The user interface 510 allows the user to select different ranking methods and presents the search results ranked by the ranking method selected by the user.

The user interface 510 also may offer the user the option to provide his intention or search objectives using a drop down menu or in free text form. The user's intention or search objectives can be provided to the concept and semantic analyzer 520 for analysis to guide the generation of proper queries by the search query generator 530, and can also be provided to the semantic filter 560 and/or to the categorizer and ranker 570 for filtering, categorizing and ranking the search results. Since the program is run on a user's local computer, the user's history and personal preferences 590 can also be made available to the semantic filter 560 and categorizer and ranker 570 to personalize the selection, categorization and ranking of the search results without sacrificing the user's privacy.

Search Using Files on Computer

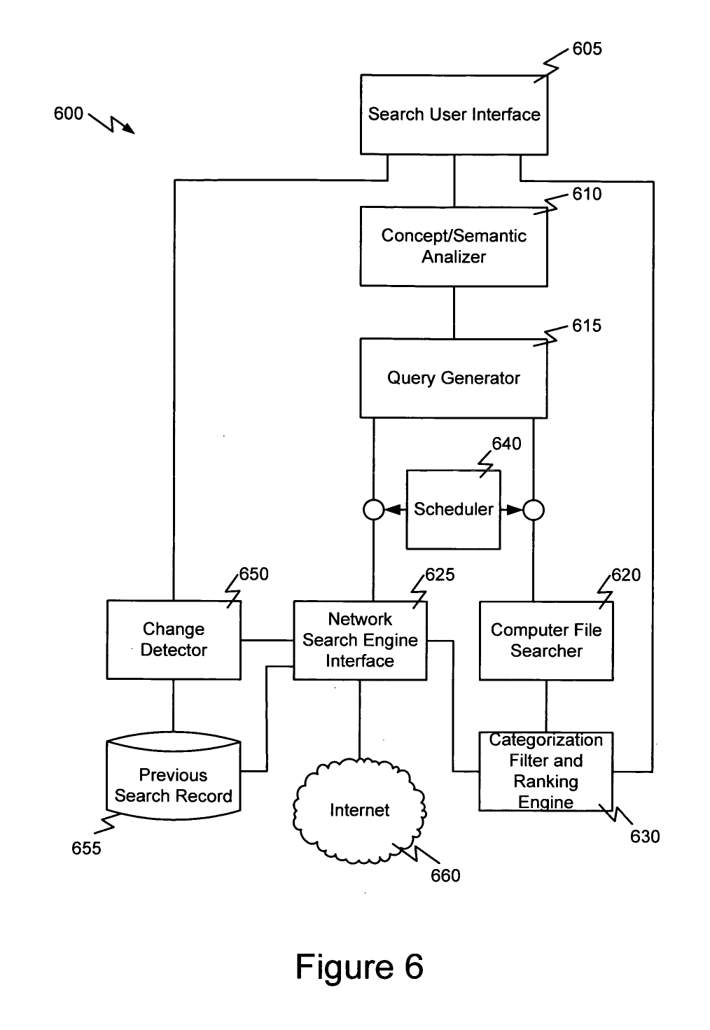

FIG. 6 is a block diagram illustrating components of a file-based search program according to one embodiment of the present invention. Such a program can be installed on a user's computer and allows a user to select one or more files on his computer, and initiate a search to “find files related to these files”, using the search user interface 605. The search user interface 605 may also offer the user options on what types of search results to search for, e.g., dates, types, sources, contents categories etc., of files on the computer and web pages on the Internet, and may also offer user options to specify whether the search is for the common concepts (intersection) of the selected files or the union of the selected files, the objectives of the search, the amount of time to spend on the search, when to do the search e.g., right away, during idle time, or a scheduled time, etc. A scheduler implements this option and allows the user to provide advice on what to look for (advices may be in general or vague terms, they are not the exact keywords to match) and how to rank the search results.

The search program includes a concept/semantic analyzer 610 that analyzes the selected file(s) and user's search objectives and advice, if provided, and performs concept extraction and summarization of the selected file(s) and of the union and/or intersection of the selected file(s). The extracted concepts and summaries are provided to a query generator 615 that generates keyword search strings to be used in the search.

If on-computer search is selected, the query generator 615 sends the search strings to a computer file searcher 620 that searches the files on the user's computer. If network search is selected the query generator 615 sends the search strings to a network search engine interface 625 that searches for matches over a network (either intranet or Internet). The network search engine interface 625 can be configured to expand the search by following links, to a certain depth, on found pages or web services, like a web crawler. After the search results are returned, they are sent to a categorization, filter and ranking engine 630 that categorizes, filters and ranks the search results with the assistance of the concept/semantic analyzer 610. After this is done, the search results may be sent to the search user interface 605 to be presented to the user.

Always-On Search

A user's interest in a search topic is often sustained over a period of time, not just in one search at one time instant. In such cases, a user may wish to monitor changes on some websites or pages that he identified during a search, and may wish to be able to continuously look out for new websites or pages that may emerge on his topic of interest.

According to one embodiment of the present invention, a user maintains a file or a folder of file(s) called My Current Interests. Such a file may be generated from the search program in FIG. 6. A scheduler 640 periodically submits search requests to the network search interface to repeat the same searches at scheduled times. When search results are returned, they may be sent to a change detector 650 that compares the search results with previous stored search results of the same searches in previous search record 655. The change detector 650 detects changes in identified sources and new sources in the new search results. If new information or a change is detected, it may be either written into a file in the My Current Interest file or folder for the user to review, or an alert may be sent to the user to inform him of the changes of new sources.

The previous search record 655 stores the sources, e.g., URLs, of all search results found the last time searches were conducted, and message digests or parity checks of the contents of the sources the user wants to monitor. In one embodiment, the user decides what sources to monitor and only these selected sources are stored in the previous search record 655 for change detection. Parity check and message digest methods are well known methods used for network security. They can be used for change detection so that only parity checks or message digests need to be stored, instead of entire pages or contents of the sources to monitored. This reduces the storage space and achieves faster change detection. To save a user's time waiting for downloading, the network search engine interface 625 can be programmed to automatically download and save pages or documents meeting the user's search specification. Thus, this automated, always-on search program keeps on searching for new sources, monitoring changes, categorizing, and downloading for a user. This is in contrast to a user having to constantly go to a search engine website, e.g., Yahoo and Google, type in all search strings of interest, search, and scroll over page after page.

If a user wants to discontinue an always-on search, he simply removes the search from the My Current Interest file or folder. If a user wants to add a new always on search, he simply adds a new entry in the My Current Interest file or a new file in the My Current Interest folder. Such always-on search is very useful to users in a wide range of applications, such as market intelligence monitoring competitors, shopping comparison monitoring price changes and new retailers, research monitoring new developments and discoveries, etc., and can save such users a large amount of time and give them better and faster awareness on the subject of their interest.

In the above embodiment, the always-on search is controlled, scheduled and initiated on a user's local computer. In another embodiment, a web search engine provides an always-on search service to its users. According to this embodiment, a user may submit to a web search engine a description or file-based on which an always-on search is to be conducted. The web search engine accepts the user's input, creates an always-on search process for it, and performs the always-on search functions as described above for the user, including analyzing the user's input, generating search queries, scheduling searches periodically to monitor specified sources for new content and the emergence of new sources, filtering and analyzing the changes or new sources detected, and informing or alerting the user.

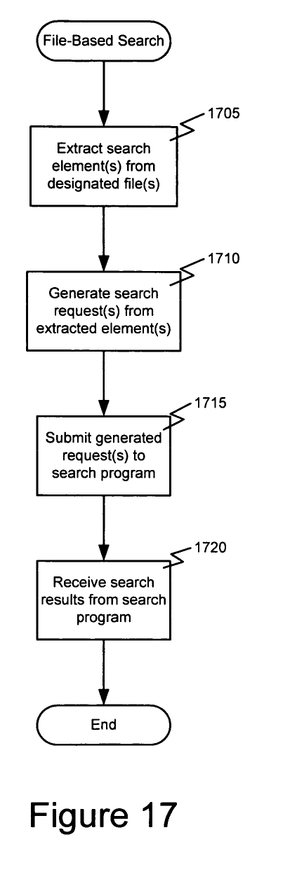

FIG. 17 is a flowchart summarizing a file-based search according to one embodiment of the present invention. In this example, processing begins with extraction operation 1705. Extraction operation 1705 comprises extracting one or more search elements from at least one designated file in one or more processing devices. A search element can be one or more keywords, a characteristic of a file, a category of a file, a textual description of a preference of the search, an objective of the search, or any combination of these or other such elements.

Next, at generate operation 1710, one or more search requests can be generated using the extracted search elements. The search requests can include requests to search files in one or more specified sources, files that are listed in or linked to entries in a recent document folder, files that are recorded in or linked to items that are recorded in a web browser's history log or favorites folder of the user, or others. According to one embodiment of the present invention, when a user views, writes, edits or processes a file in an application program, the file may be designated so that the one or more search requests are generated using the file. An application program comprises software, program, code or processes that executes or runs or is carried out in one or more processing devices and performs information processing, information storage, information access, information display, information communication, user interaction, information input, information output, computer network communication, etc. Examples include Microsoft Office, email software, web browser, Access database, personal information management software, Oracle database, business intelligence software, business process management software, web service software, middleware, IBM websphere, web service platform, etc.

Submit operation 1715 comprises submitting the generated search requests to a search program. Control then passes to receive operation 1720. Receive operation 1720 comprises receiving search results from the search program. The search results associated with a search element extracted from the designated file can then be displayed in various conditions. For example, the search results may be displayed when search results are received from the search program, when the search element in the designated file is currently displayed in an application program's window, when the user selects the search element in the designated file, etc. In some cases, other processes such as filtering, categorizing, ranking, extracting an abstract or summary from the search results, etc. may be performed on the search results. According to one embodiment, search results may be incorporated as hyperlinks in a designated file. For example, one or more hyperlinks to a search element or element combination may be incorporated in a file, and responsive to the user using an input device to select one or more of the hyperlinks, the search results associated with the search element or element combination can be displayed.

According to one embodiment, the search can be repeated periodically. For example, the search as shown in FIG. 17 can comprise generating repeated search requests, submitting the generated search request to a search program over a period of time based on a schedule, and receiving search results from the search program. Then changes can be detected between search results of a first search performed at a first time and a second search performed at a second time later than the first time. The user can then be informed when a change is detected. Detecting changes between the second search results and the first search results can be accomplished by comparing a digital digest computed from the second search results with a digital digest computed from the first search results. The repeated search requests can comprise search requests for searching a list of specified sources. In such a case, changes in the sources listed in the first list of specified sources can also be detected.

Automated Search Within an Application

In many cases, when a user is working inside a first application, such as typing a research paper or a project report or a business plan in a word processing application, he needs to frequently search for information over the network and/or on his computer. Usually, the user needs to start a web browser or a search interface and type in what he wants to search, then search and read through the retrieved results, then switch back to the first application. Such searches may often be either too limited because the user does not search all topics or concepts used in the first application, or too broad because the context of the contents in the first application are not provided to or taken into consideration in the search.

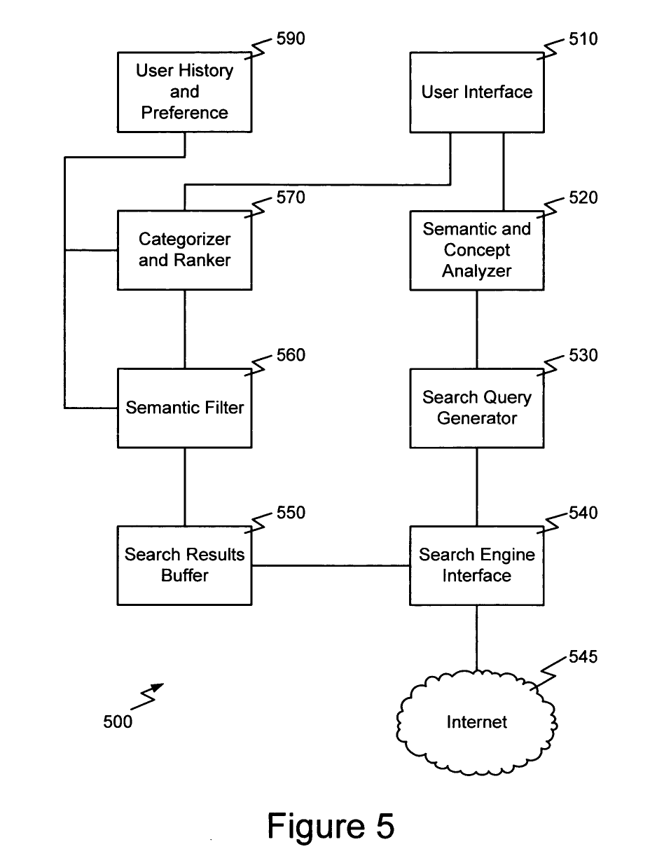

According to one embodiment of the present invention, a search program automatically searches for files, documents and web pages that are related to the file the user is working on inside a first application. For example, as a user is typing in a research paper in a word processing application, the search program equipped with a concept/semantic analyzer, a search query generator and search interface, such as the one shown in FIG. 5 and discussed above, automatically analyzes the word document, identifies the concepts, topic or theme in the document, generates search queries, and searches the user's computer, intranet and/or Internet for related files and web pages. The search results are then linked to keywords, sentences or paragraphs in the document the user is working on. The links may be shown as a colored, highlight, or superscript or subscript text. Such indications of links may not be printed and may only show on the display. There can be a “view” option to turn on or off such links on the display. When the user clicks on such a link, a separate window or a side window inside the first application shows the search results. The search results may be organized into categories and ranked. The categorization and ranking may have similar functions and features as described previously. A user can enable or disable such in-application searching, and set the extent of the search to within a directory, within a hard drive, within the computer, within an intranet, and on the Internet. In one embodiment, when a user quotes a source in the search results, the search program automatically adds the source to the bibliography of the document.

The search program can be programmed to perform any processor intensive operation in the search process in times that the processor and disk are idle so that such search processing will not significantly affect the speed of the first application. With present day multiple GHz processors, this is achievable because the computer's processor is mostly idle when running applications like word processing, spreadsheet, database, etc.

This in-application search can be integrated with the always-on search function described above such that the search program continues to search for related information during the time period the user is not working on the document. This ensures that the user gets the up to date information relevant to his writings.

Advanced Computer File and Information Management System

Files can be related in multidimensional relationships, such as categorical membership, similarities, association, time, file types, links and references in the file, sources, authors, causal relations, file set membership, conceptual relationships among files, etc. A search of these files can again be multidimensional. For example, similarities can be measured by keywords matches, common topic or subject, containing same or related sentences, paragraphs, quotes, or references. Association can be by concept expansion, opposite concepts, co-occurrence, logic, pattern etc. Time relationships can be defined by time periods in which files are created, modified or accessed. Causal relationships between files can be defined by which files are the response to which files (for example, email thread), or the reference relationships or the sequential orders files dealing with a similar topic are created. A file set membership is defined as a group of files that are related to or belong to a transaction or project.

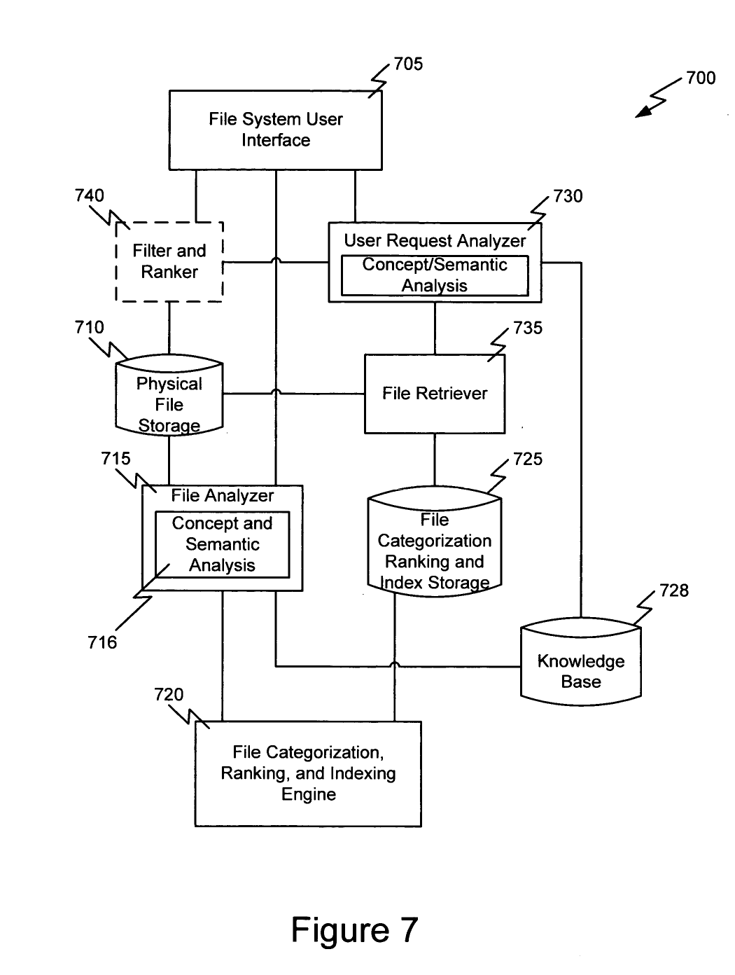

An embodiment of the present invention organizes files on a personal computer on multiple dimensions of relationships and provides multiple ways for users to retrieve files. A file organization program, as shown in FIG. 7, installed on a computer analyzes and organizes all files stored on the computer in the background during the idle time of the CPU and disk or when the CPU and disk access bandwidth are not fully utilized. This way, the files are already indexed, categorized and organized by a large number of keywords and concepts, and along multiple relationships. Thus at the time of retrieval by a user, no extensive file search is required and the file(s) can be found quickly and presented to the user. Also, the program works in the background using spare or idle resources. Therefore, it does not affect the performance of the computer or other applications running on the computer. During system idle time or when there are spare CPU and disk access resources, a file analyzer 715 retrieves files that are stored on a physical file storage 710 (e.g., hard disk drive) that have not been analyzed, and analyzes each file. The file analyzer 715 extracts applicable information from a file that characterize the file, including title, subtitles, keywords in the text, proper names in the file, captions, abstracts or summaries, dates used in the file, authors, links, references, dates it is created, modified, and accessed, etc. The file analyzer 715 may contain a concept or semantic analysis component 716 that estimates the meaning and concepts, or their probabilities, expressed by the texts in the file-based on the texts and with the assistance of a knowledge base 728. The semantic analysis capability in the file analyzer 715 elevates the characterization of files from the low level of words match to a high level of conceptual or meaning match.

The file analyzer 715 may also have a file summary component that automatically extracts an abstract or short summary of the file. The abstract or summary can be used to for the classification of files based on topics or subjects and conceptual similarities. The file analyzer 715 sends the analysis results to a File Categorization, Ranking and Indexing Engine (FCRIE) 720 which categorizes, assigns a rank, and indexes the file-based on the information characterizing the file that are extracted and provided by the file analyzer 715. The FCRIE 720 may categorize a file into multiple categories and classifications based on the different information, such as keywords, concepts, semantic analysis, functions, authors, dates, multiple levels of conceptual relationships among files, etc., contained in the file, and build an index that allows the file be quickly retrieved based on the many different characterizing information of the file, e.g., the many different keywords or concepts used in the file. For each categorization or keyword or concept match, a rank is assigned to the file that represents the importance of the file in the categorization or the closeness of match with the keywords or concepts. The results of the categorization, ranking and indexing are saved in a File Categorization, Ranking and Index Storage (FCRIS) 725. When a new file is created or received on the computer, the event is detected and the file analyzer 715 automatically retrieves the file, analyzes it and passes it to the FCRIE 720 to categorize, index and rank the file. The results are stored in the FCRIS 725.

The FCRIE 720 may use the knowledge in the knowledge base 728 in the categorization, indexing and ranking of the files based on the characterizing information of the files provided by the file analyzer 715. The knowledge base 728 can be updated manually or with a download, and may be equipped with a learning capability that learns new concepts, semantic categorizations and rankings and improves existing concepts, semantic categorizations and rankings from interaction with the user.

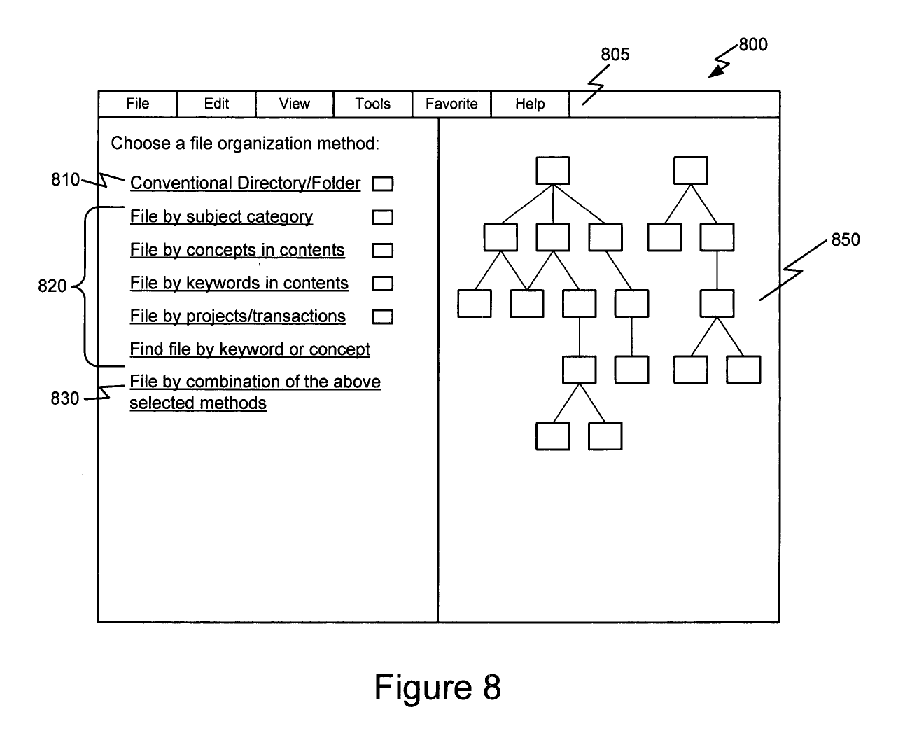

To locate a file or navigate the file system, a user clicks on an icon that brings up a GUI window 800 as shown in FIG. 8 that presents the user with multiple choices. Alternatively, the GUI window can be automatically started at start-up time. In the left of the window, multiple methods for organizing and locating files are presented in 810 and 820. A conventional folder file system is made available as one option 810 to the user. It can be used to provide the underlying file structure for the new file system in one embodiment of the present invention. Other choices presented to the user may include, as shown in 820: file by concepts or topics covered in the file; file by pre-defined subject category and subcategory hierarchy based keywords or concepts in the files; find file by keywords or concept search; find files similar to selected file(s); locate by finding files that are related to selected file(s) in time or transaction/project; File by author; etc. Another option is organization by a combination of two or more of the above choices as shown in 830. An example is file by category plus conventional directory/folder structure where the directory/folder structure of all files in a specified category is shown. A user may be given the option to configure his own preferred combination. On the right of the window 800, a chosen or default file organization view is shown. A categorization view is illustrated in 850.

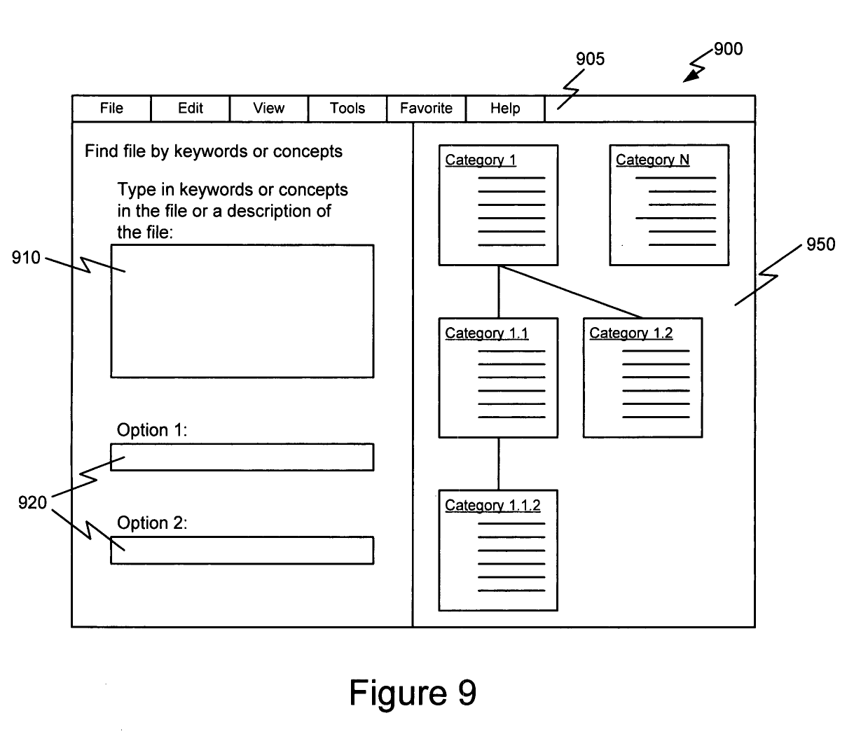

FIG. 9 shows an example of a user interface of a file organization system for finding files by keywords or concepts or description according to one embodiment of the present invention. In one embodiment of finding file by keywords or concepts or description, a user locates a file by typing in a description of the file in a text box 910 (e.g., 2004 financial budget spreadsheet). This is not a simple keyword or file name search since the words a user typed in text box 910 may not be in the file name, and may not be the exact words used in the file. Referring back to FIG. 7, the words a user types in box 910 may be sent to a user request analyzer 730 that has a concept or semantic analyzing component and works with knowledge base 728 to extract possible characterizing information from the user input that can be used to search for files. The characterizing information may include abstract concepts, keywords, categories, file types, dates, etc. In the above example of searching for file(s) using the description of 3004 financial budget spreadsheet, the user request analyzer 730 can extract characterizing information that can include: a spreadsheet file type such as Microsoft Excel, rows or columns of numbers or dollar amounts; row or column headings such as month or quarter in increasing order in various formats (e.g., Jan., Feb., Q1, Q2, 1/04 etc.) and year in various formats (e.g., 04, 2004); keywords such as cost, income, sales, revenue, salary, budget, financial; etc. The extracted characterizing information is sent to a file retriever 735 which searches the FCRIS 725 for matches.

The file retriever 735 uses the matches generated from the FCRIS 725 to retrieve the actual files or their locations in the physical file storage 710. The retrieved files or their characterizing information may be sent to an optional filter and ranker 740 that further filters and ranks the retrieved files, based on how well it matches the characterizing information of the file(s) to be found, before presenting the results to the user. Afterwards, the search results are presented to the user in a structure and ranking method that are default or chosen by the user. For example, the search results are presented with a categorization hierarchy 950 and ranked by closeness of characterizing information match in each category as shown in FIG. 9. The user may click on a folder or file icon to open it.

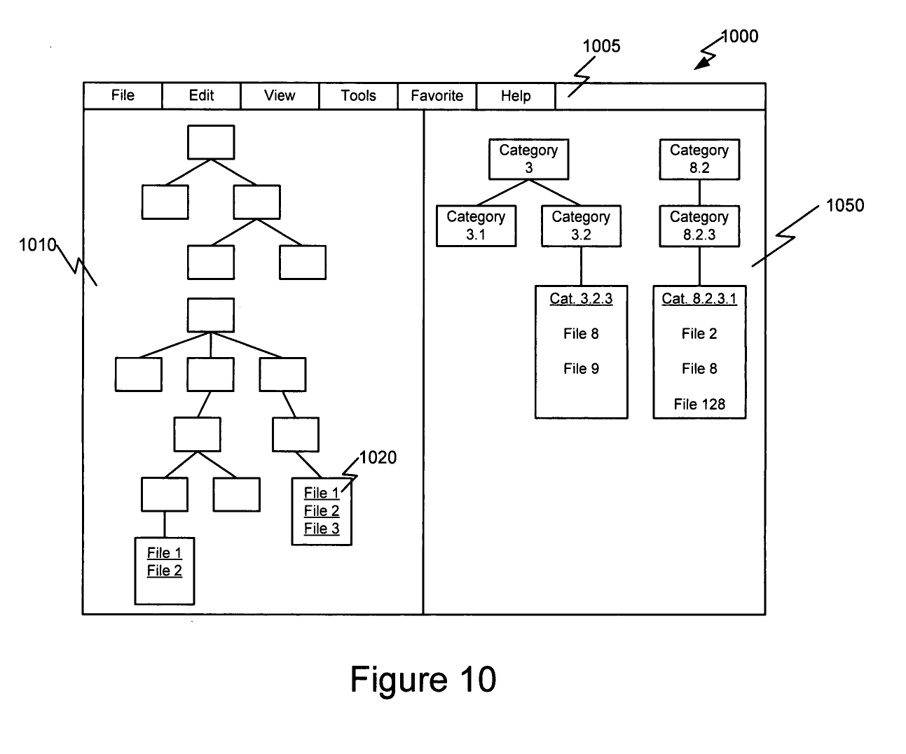

According to one embodiment of the present invention, when a user select or opens a file, a side window can be opened to show files on the computer that are related to the selected or opened file as shown in FIG. 10. Shown in 1010 are files of interest organized into categorization trees. One file 1020 is selected by the user. On the right side, files that are related to file 1020 by various relations are listed, including by topic or subject similarity, by similar keywords or concepts which can be defined by the user or by statistics such as highest occurring concept, by time relation such as created or modified during the same time periods, by same author(s), by reference or links such as referred/linked to, or by containing similar or opposing propositions as described later in descriptions of FIG. 10, etc. This function can be combined with various embodiments of the file-based search using file(s) on a local computer described earlier so that both related files on the computer and on a local network or the Internet can be shown in a side window.

Since the categorization, ranking and indexing along the many pre-defined dimensions of relations are done when the computer has spare resources, not at the time when a user is locating or searching for files, the results can be quickly available. Essentially it is available right after a user clicks or types in what he wants to find, rather than waiting for a search to go through an entire disk of many tens of GBs. When the program is first installed on the computer, it may require some time before it is ready to be used because time is needed to retrieve, categorize, rank and index all the files.

In another embodiment of the present invention, a program builds a history of a user's interaction with his personal computer as one of the methods to organize the files on the computer. The program tracks what is done in a day, such as web pages visited, emails received and sent, files worked on, applications used or installed, etc., and stores such information in a file or database. A semantic analyzer in the program can extract from such a file or database important concepts or topics, and common themes or a summary of a day, and can also extract weekly and monthly themes or summaries. This will allow presenting files to the user with a file organization by both time and by topic or theme. In addition, it can make a user's activity history searchable on a computer using the above file organization program, and present a daily, weekly, and monthly-summarized views of the user's work on the computer.

In yet another embodiment, the file organization includes emails, contacts, and tasks, such as those provided in the Microsoft Outlook program. The file organization program 700 analyzes, categorizes, ranks and indexes each email, contact and task, similar to other files. For example, persons in the contacts database can be categorized together as groups automatically if an email addressed to these persons is received or sent. A name for the group can be automatically generated using the subject of the email, or dates, or names of the some of the persons in the group, or a combination of the above. The group name can be manually edited. Each contact can be classified into multiple groups. In addition, links are indexed and recorded in the index for each email to all emails that are related by thread, date, sender, recipient, subject, and topic or concept, and each email can belong to multiple threads, concepts, or topic relevancy groups. For each email, if there are files that deal with related subjects, or topics or concepts, or a file is downloaded as an attachment from an incoming email or to an outgoing email, links to these files are also indexed and recorded for the email. Similarly, when the file organization program 700 analyzes, categorizes, ranks and indexes files, if a file is related to emails, contacts or tasks by subject, topic, concept, attachment, or other relationship, links from the file to the related emails, contacts or tasks are indexed and recorded for the file. For example, if a file that is emailed to a person in the contacts database, a link from the file to the entry of the person in the contacts database is created, recorded and indexed. If an email is deleted, the link from a file to the email can retain the information on the sender, recipient, subject, and time of the email the file is related to.

The same analysis, categorization, ranking and indexing described above can also be applied to the web pages a user visited over a period of time, such as those kept in the “history” folder of a web browser. Typical web browsers only list and organize websites or pages visited by days or weeks the sites or pages were viewed. A user often faces the problem of trying to recall a certain piece of information that he read off the Internet a few days or weeks ago, but forgets exactly which day it was viewed, forgets the URL and the keywords used to find the information. To solve this deficiency, the file organization program 700 analyzes, categorizes, ranks and indexes websites or pages in the “history” folder into categories with ranking by keywords, concepts and semantics, authors, dates, relationship with files on the computer, etc., so that a user can search the websites or pages in the history folder by concepts, or descriptions (not limited to keywords), or date period (rather than limited to exact date), or authors, etc. Note that the websites and pages in the “history” folder do not need to be stored on the user's computer. The file organization program 700 retrieves the pages from the Internet to analyze, categorize, rank and index them, but the pages do not need to be stored on the user's computer after the file organization program 700 finishes. In some cases, only the categorization, ranking and indexing information may be stored on the user's computer. For users who want privacy of viewing history, this function can be protected in the file organization program 700 by password, or disabled, or deleted when the “history” is deleted. The same method or file organization program 700 can be applied to automatically organize the web pages in the “favorite” list.

The embodiments of the present invention for computer file organization are similar to the embodiments for web searching and file-based searching, but they are adapted to be used as a method to retrieve files on a computer in multiple ways and to organize files and information in a computer. These embodiments will enable a user to organize and retrieve information on his computer and over the Internet effectively and intelligently. For example, a user will be able to retrieve a file by specifying that it discusses the effect of global weather changes over the past 100 years or so (but may not contain these exact words, this is a search for concept similarity), was authored by a group of scientists, one of whom is from an Asian country (author but defined by concepts, not name), it was first retrieved off the Internet (source) when the user was searching for information on the rainforest on the Internet (co-occurrence), and a modified version of the file was emailed to a person in the contacts database about 3 months ago (source and email attachment relationship).

The various embodiments of the present invention for computer file organization provide a high-level file system that organizes files into categories, according to relations among files, and in ranking orders along multiple categorization and ranking dimensions and multiple levels of conceptual relationships.

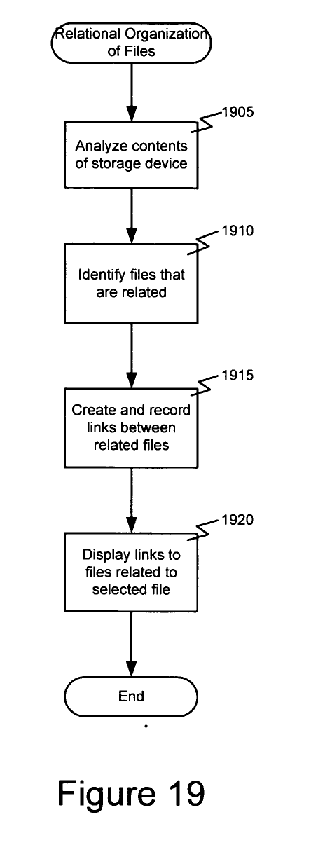

FIG. 19 is a flowchart illustrating relational organization of files according to one embodiment of the present invention. In this example, processing begins with analysis operation 1905. Analysis operation 1905 comprises analyzing contents of one or more storage devices. At identification operation 1910, files within the contents of the one or more storage devices that are related are identified. Identifying files that are related can comprise identifying two files as related if both contain the same or similar keywords, concepts, predicates, propositions, patterns, both are related to the same transaction or project, both are created, edited or viewed within a same period of time, or both are authored by the same person or related persons.

Control then passes to create operation 1915. Create operation 1915 comprises creating and recording links between the files that are related. Finally, at display operation 1920, recorded links to files related to a first file when the first file is selected or opened in an application window can be displayed.

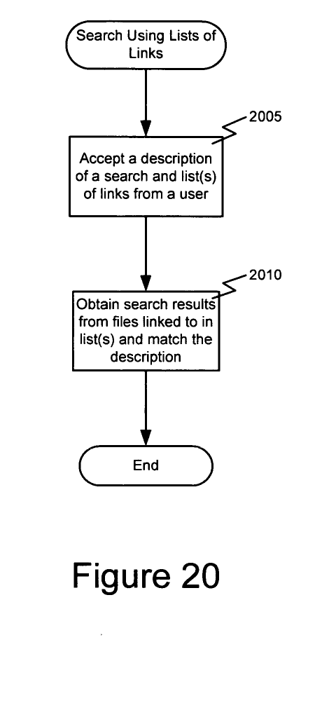

FIG. 20 is a flowchart illustrating a use of lists of links to search for information according to one embodiment of the present invention. Here processing begins with input operation 2005. Input operation 2005 can comprise providing a user interface that accepts a first description of a search and one or more lists of links from a user. The one or more lists of links can comprise a list of URL links in a history log of a web browser, a list of links in a favorites folder of a web browser, a list of links to files in a recent documents folder, a list of links to files in a set of designated folders, etc. Alternatively, input operation 2005 can comprise providing a user interface that allows a user to select which lists of links to be included, allows a user to define a list of links are to be included, or allows a user to use one or more lists of links located on another processing device on a network.

Next, at match operation 2010, search results can be obtained from a search of files that are linked by an entry in the one or more lists of links and containing information that matches the first description. Alternatively, matching may comprise accessing or downloading files that are linked to in one or more lists of links, and performing on a processing device operated by a user the search in the files that are linked to in the one or more lists of links for information or files that contain information that match the first description. Search results obtained from a list of links can be grouped into a category for each list of links.

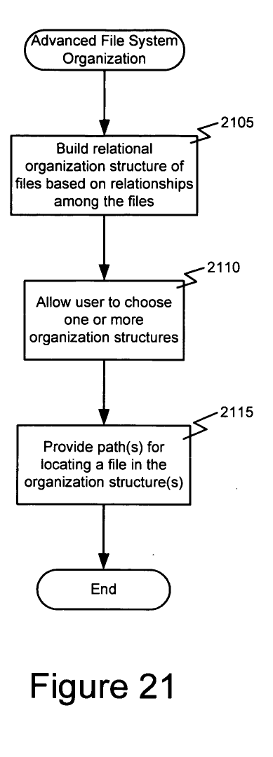

FIG. 21 is a flowchart illustrating advanced file system organization according to one embodiment of the present invention. Here, processing begins with build operation 2105. Build operation 2105 comprises building, in addition to a file-folder organization structure, at least one relational organization structure of a plurality of files in one or more processing devices based on one or more relationships among the files. The at least one relational organization structure can comprise a taxonomical categorization hierarchy based on one or more characteristics of the plurality of files, a taxonomical categorization hierarchy based on contents of the plurality of files, a network structure based on links from one file to another file, a set-membership structure based on one or more characteristics of the plurality of files, a structure based on one or more logical, statistical, time or storage location relationships among the plurality of files, etc. Further, the plurality of files can comprise files stored in one or more hard disks, files that are listed or linked to in a history log or favorites folder of a web browser, files that are listed or linked to in a recent documents folder, files that are listed or linked to in a set of designated folders, a set of specified types of files, a set of files containing one or more specified items of information, a set of files with one or more specified characteristics, etc.

Control then passes to input operation 2110. Input operation 2110 can comprise providing a user interface that allows a user to choose one or more designated organization structures from a set of organization structures that includes as choices the relational organization structure and the file-folder organization structure.

Once one or more organization structures are chosen, one or more paths for locating a file in the one or more organization structures from organization structures at output operation 2115. Further when the user selects a first organization structure and a second organization structure, the plurality of files can be into the first organization structure, and files within a category or subset or node of the first organization structure can be organized into the second organization structure.

Additionally, files within a chosen relational organization structure can be ranked using methods described herein. For example, files belonging to a subset of the at least one relational organization structure can be ranked based on one or more weighted ranking dimensions. A user interface can be provided to allow a user to define or select a weight vector for one or more weighted ranking dimensions. The subset of files can then be ranked by applying the weight vector selected by the user.

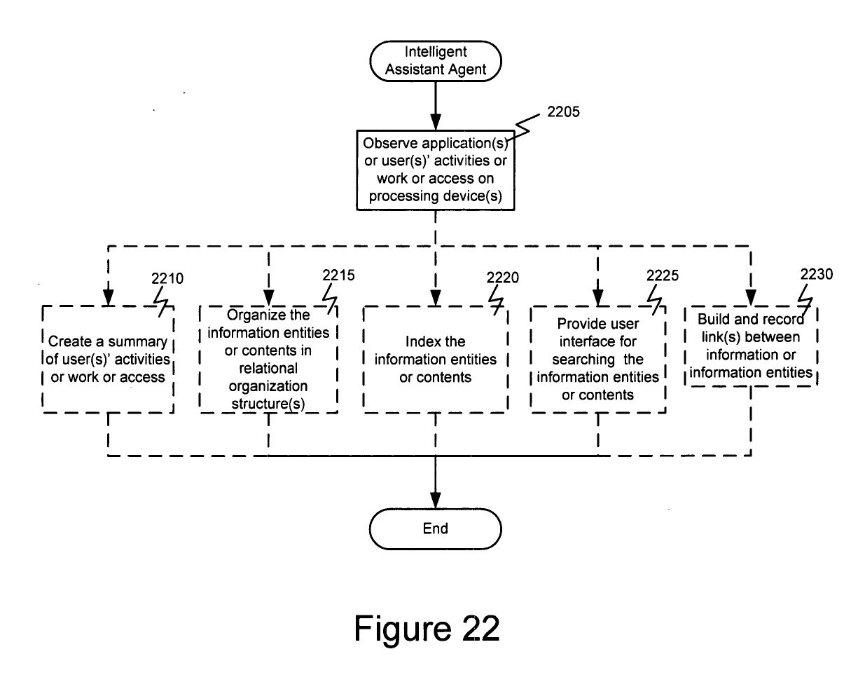

FIG. 22 is a flowchart illustrating processing of an active intelligent file organization according to one embodiment of the present invention. In this example, operation begins with observation operation 2205. Observation operation 2205 comprises observing one or more applications or one or more users' activities on one or more processing devices over a period of time. According to one embodiment, a user interface can be provided to the user to allow the users to choose what applications or activities on the processing device are observed. Operation then continues with one or more optional operations.

Additionally, relationships between files or information entities in a relational organization structure can be determined in a number of ways. For example, a file can be designated as related to a name in the file or contact database if the file is sent to or received from the contact with the name, the name is listed as an author of the file, or the file contains the name in a part of the file. A file can be designated as related to an email if the file is an attachment to the email or the file and the email contain related contents. A file can be designated as related to a task or project if the file is referred to in the task or project or the file and the description of the task or project contain contents that are related.

Optional create operation 2210 can comprise creating a first summary of contents of the one or more users' activities in the period of time.

Optional organize operation 2215 can comprise organizing, by at least a first relational organization structure, the contents of the information entities or the information entities which are involved with the one or more applications or with the one or more users' activities in the period of time. An information entity can comprise one or more files, web pages, emails, databases, or entries in a database. A relational organization structures can comprise a categorization or grouping of the contents in the information entities or the information entities based on the information in the information entities. Alternatively, a relational organization structure can comprise one or more groups of contacts or email addresses in a contact database wherein a contact or email address is included in a group if emails or files associated with the contact or email address are related to the emails or files associated with one or more other contacts or email addresses in the group.

Optional index operation 2220 can comprise indexing the information entities or the contents of the information entities which are involved with the one or more applications or which the one or more users' activities in the period of time. Indexing the information entities or the contents in the information entities can comprise indexing one or more emails the one or more users send or receive or one or more web pages the one or more users access or work on.

Optional output operation 2225 can comprise providing a user interface for searching the information entities or the contents of the information entities which are involved with the one or more applications or the one or more users' activities in the period of time. Providing a user interface for searching the information entities or the contents of the information entities can comprise providing a user interface for searching one or more emails which the one or more users send or receive or one or more web pages which the one or more users access or work on. The intelligent agent can also provide a user interface that allows the retrieval of files linked with a name in a file or in a contact database, the retrieval of names that are linked with a file, the retrieval of files linked with an email, the retrieval of emails that are linked with a file, the retrieval of files linked with a task or project, and the retrieval of tasks or projects that are linked with a file.

Optional link operation 2230 can comprise building and recording one or more links between at least a first information or information entity and a second information or information entity. Recording one or more links between the first information and the second information can comprise recording a link between a first file and at least one name in a second file or in a contact database in a personal information management application if the first file is related to the name, recording a link between a file and at least one email if the file is related to the email, recording a link between a file and at least one task or project in a task or project management application if the file is related to the task or project, etc.

Intelligent Assistant Via Unattended File and Web Searches and Associations

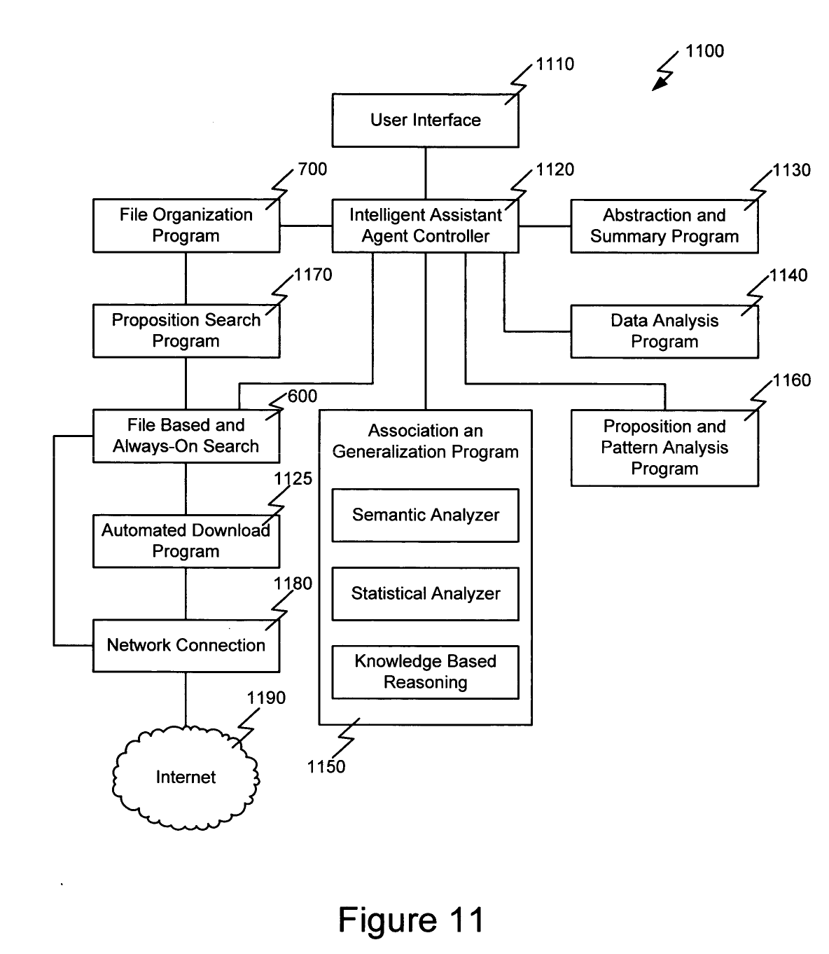

Embodiments of the present invention tap into the four underutilized resources identified at above to provide intelligent assistance to a user in researching and innovating. Various embodiments of the present invention provide automated functions that provide assistance in a user's personal or business intelligence collection and analysis, and creative work through automated fact finding, information retrieval, analysis and abstraction, change detection and monitoring, and new concepts or idea creation by association, reasoning and generalization. An exemplary embodiment of such an intelligent assistant agent is shown in FIG. 11. The intelligent assistant agent 1100 is built with the previously described file-based search and always-on search program 600 shown in FIG. 6 assisted by an automated download program 1125, and the file organization program 700 shown in FIG. 7. A user may instruct or configure the intelligent assistant agent 1100 through a user interface 1110. Examples of such instruction or configuration include files and/or text descriptions of a user's objectives based on which information and intelligence collection on the web is to be conducted, sources to monitor over a period of time, methods of alerting the user, configuration of the intelligent assistant agent 1100 to automatically generate objectives and tasks by tracking and analyzing the user's interaction with the computer and the files the user is working with on the computer. An intelligent assistant agent controller 1120 schedules and coordinates the various functions. The intelligent assistant agent controller 1120 with the assistance of the concept and semantic analyzer in the file organization program 700 or the file-based search and always-on search program 700 analyzes the user's instruction or description, or user's interaction with the computer and the files the user is working with on the computer. Based on these analyses, the intelligent assistant agent controller 1120 generates objectives and tasks to achieve the objectives. It then schedules the tasks based on the user's instructions or configuration. These tasks are typically performed automatically in the background.

The intelligent assistant agent controller 1120 interacts with the file organization program 700 to analyze and incrementally categorize, rank and index files on the computer based on the concepts and file relationships that will facilitate the intelligent assistant agent's objectives. Based on the objectives and tasks generated, the intelligent assistant agent controller 1120 generates one or more always-on search tasks and file-based search tasks for searching information on the computer and over the Internet. These search tasks are carried out by the file organization program 700 and by the file-based search and always-on search program 700 with the assistance of an automated crawler and download program 1125 where the automated crawler can be a component of automated crawler and download program 1125. Since the search queries are generated by concept and semantic analysis, the scope of the search is broader than the keywords used in files or user instructions.

Broadening keywords to concepts is an important step for intelligent search. However, to provide intelligent assistance to a user, embodiments of this invention move a level higher in the hierarchy of concept space to the level of propositions. At the proposition level, relationships among concepts can be captured. Also, at the proposition level, patterns of relations among concepts can be identified. Therefore, for a text file or text description, the intelligent agent controller 1120 asks a proposition and pattern analysis program 1160 to analyze the text to extract major propositions from the texts and to look for patterns of relationships among concepts. One way of identifying and extracting a major proposition is finding a sentence that contains one or more important keywords, extract the sentence, and remove unimportant adjective or adverb words or clauses. For non-text data, a data analysis program 1140 can perform statistical data analysis, regression analysis, and/or pattern detection in the variables involved. Such analysis and pattern detection can be used by the proposition and pattern analysis program 1160 in conjunction with the textual names of the variables, and the concepts related to these variables to extract patterns and propositions.

To enable a semantic search using a proposition, the proposition and pattern analysis program 1160 generalizes an extracted proposition by replacing the keywords used in the different parts of the sentence with a conceptual description that captures the semantic meaning of the replaced keywords. If the keyword(s) used in one part of the sentence have more than one semantic meaning, the keyword(s) can be replaced with a conceptual description for each semantic meaning of the replaced keyword(s), thus, generating more than one generalized proposition from a proposition extracted from a text. Given files from which propositions have been extracted and generalized by the proposition and pattern analysis program 1160, the intelligent assistant agent controller 1120 can initiate a proposition search program 1170 to search for files that contain a matching generalized proposition. The proposition search program 1170 can match two generalized propositions by matching the conceptual meaning of the corresponding different parts of the propositions and matching the relationship between the corresponding different parts of the propositions. In addition to finding matching or similar propositions, the proposition and pattern analysis program 1160 and the proposition search program 1170 can also search for files or web pages that contain propositions that are against or oppose to the semantic meanings of a given proposition. The proposition search program 1170 can find two opposing generalized propositions either by finding opposing conceptual meanings of a same part in the two propositions while the relationships between the different parts are the same or similar, or by finding the same or similar conceptual meaning of a same part in the two propositions while the relationships between the different parts are opposing. The intelligent assistant agent 1100 uses the similar and opposing proposition searching functions to provide both supporting evidence and opposing views to a file, a textual input, or a web page.

After the proposition and pattern analysis program 1160 extracts and generalizes propositions from files or web pages, the file organization program 700 and the file-based and always-on search program 700 can categorize and rank these files or web pages according to the propositions contained in these files or web pages, for both similar and opposing propositions, similar to the similar and opposing proposition searching functions described above.

The intelligent assistant agent as shown in FIG. 11 is implemented on a user's local computer. It is easy for a person skilled in the art to see that the functions of the intelligent assistant agent 1100 can also be implemented on at least one server on a network to provide intelligent categorization, ranking, summarization, organization, association, and always-on search of contents on the server or may be accessible to the server over a network. For example, a web search engine may implement the proposition and pattern analysis program 1160 and the proposition search program 1170 to support the search of web pages that contain propositions that match or are similar to, or are against or opposite of the semantic meanings of a given proposition. Similarly, a web search engine may implement the functions of the proposition and pattern analysis program 1160 to enable categorization and ranking of web pages based on the semantic meanings of the propositions contained in the web pages.

The automated search functions of the intelligent assistant agent 1100 can automatically crawl, download, analyze, and identify a large number of files. Even though the intelligent assistant agent 1100 can categorize and rank these files, there still may be too many files for a user to look through. Thus, the intelligent assistant agent 1100 has a text abstraction and summary program 1130 that extracts an abstract or summary from a text file so that a user can quickly read through much-condensed abstracts or summaries of many files. The text abstraction and summary program 1130 can obtain the abstract or summary of a text file in several ways, including collecting the main propositions extracted from a text file by the proposition and pattern analysis program 1160, identifying and extracting important sentences (e.g., first sentence of a section, sentences following identifiers such as “this article deals with . . . ” or “It is our conclusion . . . ”) or paragraphs following a title such as “abstract”, “summary”, “conclusion”, etc.

Identifying associations between concepts, principles, phenomena etc., sometimes referred to as making connections in layman's terms, is one of the most important paths in human creativity. For example, the association of a round stone rolling downhill with carrying heavy loads could have led to the invention of the wheel. The association of a sharp object with a cut on the body could have led to the invention of stone knives and spears. The association of a log floating on a river with the desire to travel on water could have led to the invention of rafts, canoes and later boats. Other examples are abundant. A part of the functions of the intelligent assistant agent 1100 is to assist a user in associative thinking by searching a lot of associations and patterns and presenting the most likely to the user. In this way, the intelligent assistant agent 1100 can make and suggest associations to the user. Since the computer, the storage, the network connection and access to information can be working 24 hours a day and 7 days a week with high processing speed and broad bandwidth, the intelligent assistant agent 1100 can search, explore, test and reason a large number of associations that a user would otherwise fail to consider.

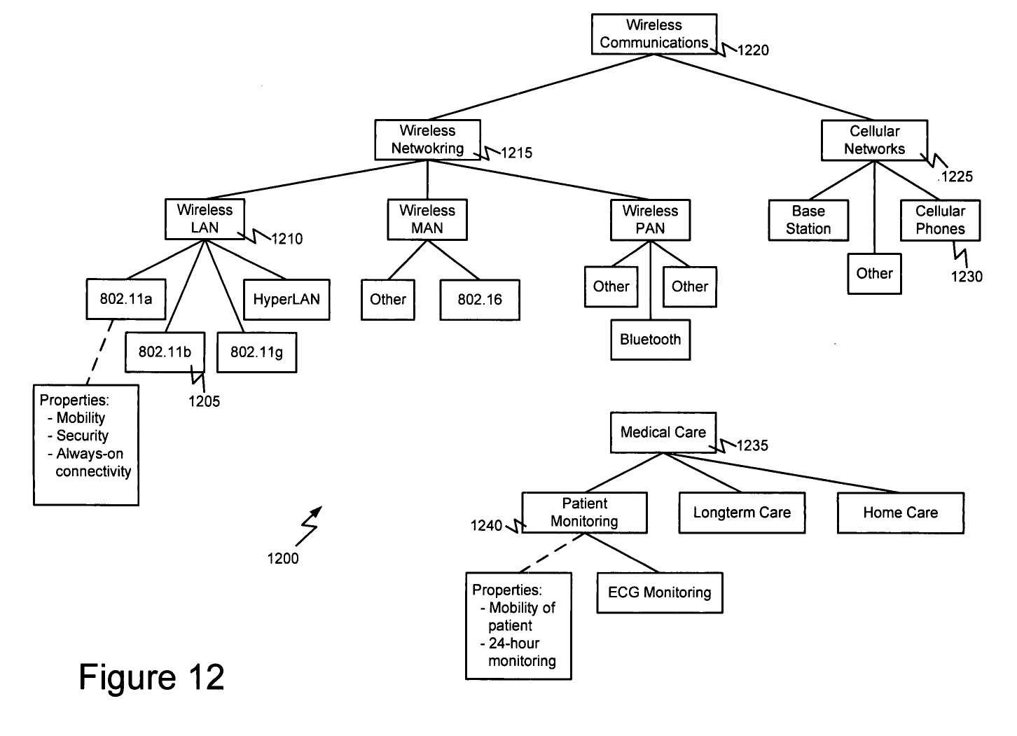

An association and generalization program 1150 can take as input concepts provided by the intelligent assistant agent controller 1120, and the propositions and patterns provided by the proposition and pattern analysis program 1160. These concepts, propositions and patterns are referred to as the input set, as example of which is illustrated in FIG. 12. The association and generalization program 1150 traverses a concept and/or proposition space, by generalization and specialization or induction and deduction, to search for concepts, propositions and patterns contained in files on the computer and over the network that can be associated with the input set with a certain relationship. For example, the input set 1200 illustrated in FIG. 12 contains the concept of 802.11b 1205, the association and generalization program 1150 moves in the concept space one level up to wireless local area network 1210, another level up to wireless networking 1215, and another level up to wireless communications 1220, then it moves down one level to cellular network 1225, and another level down to cellular phone 1230, and finds an association between 802.11b 1205 and cellular phone 1230, and presents “802.11b cellular phone” as a potential association. Other associations that can be derived include “802.11a cellular phone”, “802.11b and 802.16 and Bluetooth”, “802.11b Bluetooth cellular phone”. When these associations are presented to a person familiar with the art, they suggest possible inventions of: a cellular phone network based on the 802.11b or a or g technology; a wireless network that uses 802.16 for wireless metro area networking, 802.11b for local area networking, and Bluetooth for personal area networking; a cellular phone using 802.11b for local area connection and Bluetooth for personal area connection; etc.

An even more inventive path is to explore associations by randomly jumping to parts in the concept or proposition space that are seemingly unrelated. Using the same example as above, the association and generalization program 1150 may randomly jump to a subspace on medical care 1235 and explore associations of 802.11b 1205 wireless local area networking with medical care 1235 and patient monitoring 1240. It may present the association of “802.11b and patient monitoring” and present supporting evidence obtained by searching information on the network for the requirements of patient monitoring. The association and generalization program 1250 submits “patient monitoring” and “802.11b” and their generalizations and specializations such as wireless networking, mobility, always-on connectivity from “802.11b”; and ECG monitoring, location monitoring from “patient monitoring” etc., to the intelligent assistant agent controller 1120 which submits the search request to the file-based and always-on search program 700. The file-based and always-on search program 700 performs a concept and semantic search over the network and can return results, some of which may identify needs such as mobility and 24-hour continuity for patient monitoring, ECG monitoring, etc. These strengthen the associations of patient monitoring with mobility and always-on connectivity that are properties of 802.11b wireless networking. As a result, the association and generalization program 1250 increases the strength and ranking of the association “802.11b and patient monitoring”. When a user familiar with the art is presented with such an association, it may lead to inventions that use 802.11b and other wireless technologies for patient monitoring.

Similar associations can be made and explored by such random jumps in the concept and proposition space. Examples include jumps to toys, environment monitoring, home and office appliances, etc. Many of such random associations may not find any supporting evidence or may be ruled out by common sense knowledge, e.g., 802.11b and extinction of dinosaurs, 802.11b and relativity theory, etc.

Another method the association and generalization program 1150 can use to make associations is by searching over a network for new associations. The association and generalization program 1150 can search for web pages or files that contain any of the generalizations and specializations, or inductions and deductions of the input set and a second set of concepts or propositions. Since the second set of concepts or propositions are contained in the same web page or file, the association and generalization program 1150 assumes that there is an association, and searches for more supporting evidence. For the same example above, in it's conceptual search using the mobility and continuous connectivity properties of wireless local area networking, the association and generalization program 1150 may find a web page on the Internet that discusses the need to monitor a patient's ECG continuously over a period of time while allowing the patient to move around freely. Thus, the association and generalization program 1150 identifies a possible association between 802.11b and patient ECG monitoring.

Yet another method the association and generalization program 1150 can use to make associations is by searching for new associations from the searching and browsing histories of a group of users. This is referred to as collaborative association. In collaborative association, a server maintains the searching and browsing histories of a group of users, and makes the data available to other users, e.g., a user in the same group. To protect users' privacy, the histories can be maintained anonymously, and require a user's consent for his history to be included in the server. In this scheme, a user signs up for his searching and browsing history to be recorded anonymously on a server for other users to use for collaborative association. In return, he will be able to access and search the searching and browsing histories of other users in the group. In one case, the group of users may be from a company or department and their searching and browsing histories in the workplace are recorded for the company's benefit. In another case, the group of users may be a voluntary user group or community on the Internet. In any of such cases, the association and generalization program 1150 searches the searching and browsing histories of a group of users for what other concepts or propositions other users searched or browsed, wherein the other users also had searched for any of the generalizations and specializations, or inductions and deductions of the input set, either concurrently in the same search or sequentially in a specified period of time. This embodiment harvests the collective wisdom of a group for innovation.

The above embodiments uses both reasoning and brute force to search for associations from multiple sources, including knowledge bases, files on a user's computer, web pages and files over a network, and user histories. The association and generalization program 1150 searches associations between many combinations of concepts such as two-concept, three-concept, through n-concept associations, and associations between propositions, data patterns, expanded or higher level related concepts or propositions from core concepts or propositions of the input set, to discover potential associations. Multiple element associations can be obtained and validated transitive relations. For example, if there is reasoning or evidence supporting association of concept A with concept B, and there is reasoning or evidence supporting association of concept B with concept C, then the three-element association of concepts A, B and C can be obtained and are considered as validated.

The association and generalization program 1150 then analyzes and searches for further supporting evidence for the potential associations. Based on the analysis and supporting evidence, the association and generalization program 1150 can estimate the probabilities or likelihoods of the potential associations using statistical methods known in the arts. The potential associations can then be ranked according to such probabilities or likelihoods. In one embodiment, the association and generalization program 1150 performs knowledge based reasoning on what conclusions can be drawn from the potential associations and presents such reasoning as suggestions to the user.

As can be seen from the above description, the intelligent assistant agent 1100 is able to make a very large number of associations at various levels of concepts, propositions and relationships. It can expand the results of association by second and third level associations, meaning searching for associations among the concepts or propositions associated with the input set and its generalizations or specializations, inductions or deductions. A majority of the associations may be meaningless. Some of them can be ruled out and some will be given low probabilities or rankings by the intelligent assistant agent 1100, due to a lack of support from other files or from knowledge-based common sense reasoning. The remaining associations will be presented to the user ranked by probability or likelihood or other measures for the user to review, select or make further investigation or conclusion. The objective is that some of these presented associations may prompt a user to make a connection between some concepts, patterns, relationships, or propositions that would otherwise not be made by the user. The hope is that some of these associations suggested and explored by the intelligent assistant agent 1100 will lead a user in a direction that will come up with an innovation or invention with further exploration. This is useful because with the combination of high speed processors, broadband network connections and large information storage spaces, the intelligent assistant agent 1100 will be able to explore and make associations using a much larger amount of information and knowledge than a person can in the same period of time, e.g., 24 hours or 7 days. This is especially true when considering that the intelligent assistant agent 1100 can work nonstop without getting tired or losing concentration.

The intelligent assistant agent 1100 can automatically perform its functions by working on files or documents specified by a user or on the same files or documents a user is reading or writing. The user interface 1110 accepts user inputs and instructions, or tracks a user's interaction with the computer, and present the results of the intelligent assistant agent 1100's work to the user in various formats. In one format, the results are presented by automatically displaying links to keywords, sentences, or paragraphs in a file or document. Such a link may not be a URL, but may be instead a categorized and ranked list of URLs and files or documents on the computer. In another format, the user interface opens a second window by the side of a first window showing the document the user is reading or writing. Links may be automatically displayed in the first window, and a second windows shows the search and association results that are categorized and ranked. When the user clicks on one of links in the first window, the related search and association results may be shown in the second window in categories and with ranking. Clicking on an item in the second window may open a third window which may display an abstract or summary of the file(s) or document(s), or summary of the association and the evidence or reasoning supporting the association. After reading the abstract or summary, if the user is interested in pursuing further, he may then click and open the full file(s) or document(s). Alternatively, the third window can be configured to directly display a file or document when its link in the second window is clicked. The user interface 1110 may offer the user an option to grade the search or association result. The intelligent assistant agent 1100 can use the grades assigned by the user to improve its searching and association results. Similar to the multidimensional user selectable ranking described previously, the search and association results can be ranked in multiple dimensions, and the user can select which ranking method to use, or defined a specific customized ranking formula.

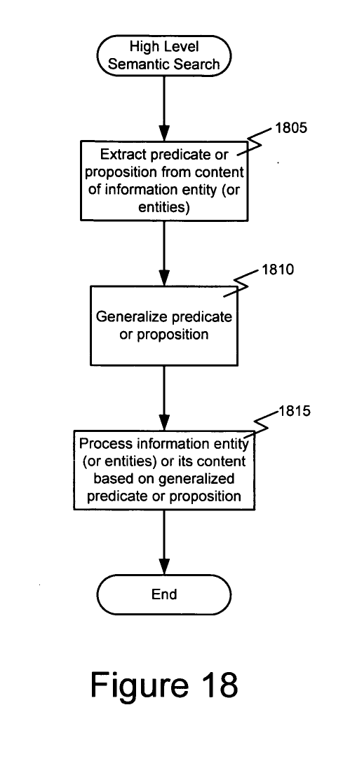

FIG. 18 is a flowchart illustrating a high-level semantic search using predicates or propositions according to one embodiment of the present invention. In this example, extract operation 1805 comprises extracting a first predicate or proposition from a textual content of one or more information entities. An information entity can comprise a file, user input, program, log of activities or work or information access by one or a group users, web page, email, database, entry in a database, software agent, knowledge base, expert system, data or information stored in a storage device or a computer, and the contents or properties of the any of the forgoing. Therefore, an information entity can be a file in a storage device, an input provided by a user, a database, a program, a log of one or more users' activities over a period of time, a file that a user is currently reading, writing or editing, or has recently read, written or edited, etc. Control then passes to generalization operation 1810.

Generalization operation 1810 comprises generalizing the first predicate or proposition to a first set of one or more generalized predicates or propositions that are related to the first predicate or proposition. The first predicate or proposition can be a member of the first set of one or more generalized predicates or propositions. Generalizing the first predicate or proposition can comprise replacing at least one part of the first predicate or proposition with a description that captures at least one semantic meaning of the replaced part.

Then, processing operation 1815 comprises processing the one or more information entities or the textual content of the one or more information entities from which the first predicate or proposition is extracted, based on the first set of one or more generalized predicates or propositions. processing the textual contents of the one or more information entities can comprise categorizing or ranking the information entities or textual content of the information entities, determining whether a generalized predicate or proposition has a relationship with another predicate or proposition, submitting a first generalized predicate or proposition from the first set of one or more generalized predicates or propositions to a search program to find one or more files that contain a second predicate or proposition that has a relationship with the first generalized predicate or proposition, etc.

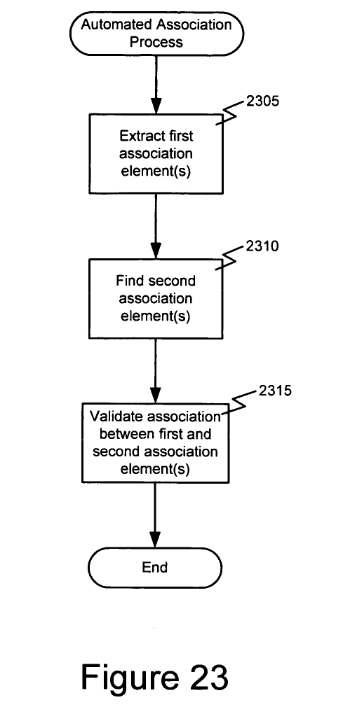

FIG. 23 is a flowchart illustrating an automated association process according to one embodiment of the present invention. In this example, operation begins with extract operation 2305. Extract operation 2305 can comprise extracting one or more first association elements from one or more information entities. An association element can comprise a keyword, a set of keywords, a concept, a proposition, a predicate, a textual description, etc. An information entity can comprise a file in a storage device, an input provided by a user, a database, a program, a log of one or more users' activities over a period of time, a file that a user is currently reading, writing or editing, or has recently read, written or edited, etc. Control then passes to find operation 2310.

Find operation 2310 can comprise finding one or more second association elements. Then, at validation operation 2315, a determination can be made as to whether there is an association between the one or more second association elements and the one or more first association elements. Finding the second association element and validating that there is an association between the first and the second association element can comprise following at least one relationship link or at least one reasoning step in a knowledge representation that connects the first association element and the second association element, jumping to a part of a knowledge representation that contains the second association element wherein the first and second association elements share one or more related characteristics, searching for at least one file in one or more processing devices that contains the second association element wherein the first and second association elements share one or more related characteristics or are present in a related context, or searching for the presence of both the first and the second association elements in at least one user's activity or web surfing or search history logs over a period of time. Validation may also comprise using a list of sources for validating an association between the one or more first association elements and the one or more second association elements. In this case, one or more first association elements and the one or more second association elements can be submitted to the one or more of the sources in the list and information from the sources that facilitate the validation of the existence of an association between the one or more first association elements and the one or more second association elements can be received.

Additionally, one or more pairs of association between the first and the second association element can be ranked and a user interface may be provided to allow a user to select or define a ranking method as discussed above.

Embodiments of the present invention save a significant amount of time for users since a user is no longer required to be glued in front of a computer to search and surf web pages and to wait for downloads. Files and web pages are automatically searched, analyzed, and summarized semantically at various levels of the concept and proposition spaces. Files and web pages a user is most likely to see based on analysis are downloaded and saved so that they can be instantly available when the user wants to read them. Embodiments of the present invention search much more broadly and explore a much wider range of associations than a user can. The summaries allow a user to sift through a large number of related files quickly, extending a person's ability to sift through a large amount of information. The intelligent assistant agent 1100 can help a user search, filter, and associate while the user is playing or sleeping.

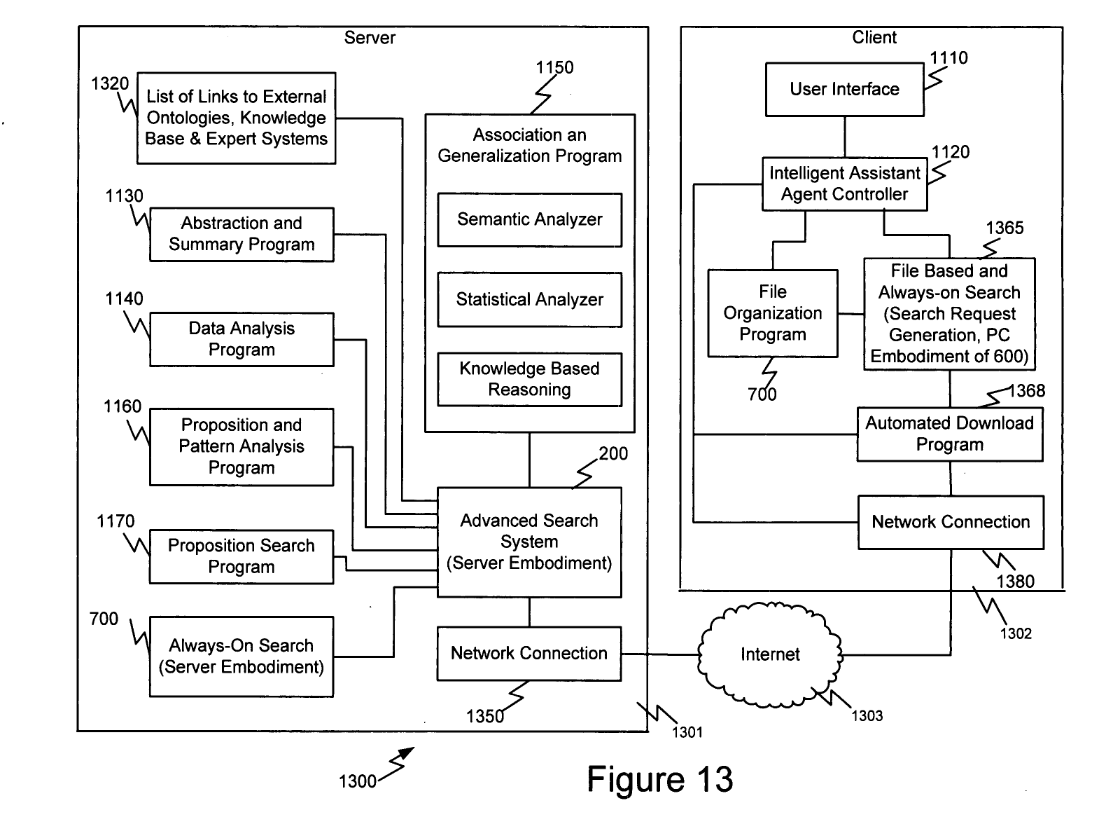

The previous embodiments of the intelligent assistant agent run on a user's local computer. In an alternative embodiment, a server-client model is used where a first server and a user's local computer collaborate to perform the intelligent assistant agent functions. FIG. 13 is one example of such a server-client model. A search and knowledge base web service provider will be able to develop and maintain high quality, manually edited ontologies, knowledge base, and reasoning algorithms for various subject areas on the first server 1301. These ontologies, knowledge bases and reasoning algorithms can be made open-ended with learning ability to improve using user feedback. The first server 1301 categorizes, ranks and indexes its own files and files and web pages on the Internet. It can take over part of the functions of file-based and always-on search program 700 and all of the functions of the proposition and pattern analysis program 1160, the data analysis program 1140, the abstraction and summary program 1130 and the association and generalization program 1150. The intelligent assistant controller 1120 in the user's computer 1302 sends all web and knowledge base searches, if not disabled by the user, to the first server 1301. The first server 1301 performs the semantic search, proposition and pattern analysis, abstraction and summary extraction, and association of the input set and its generalizations and specializations, or inductions and deductions, provided by the intelligent assistant agent controller 1120, categorizes and ranks the results and sends the results back to the intelligent assistant controller 1120 for presentation to the user through the user interface 1110.

In one embodiment, the first server 1301 maintains a list of links to various ontologies, knowledge base and expert system web services 1320. The list 1320 is open to other computers or servers running qualified ontologies, knowledge bases, and expert systems. The first server 1301 can crawl the web to search and qualify new computers and servers that run qualified ontologies, knowledge bases, and expert systems to be included in the list 1320. These computers or servers may send requests to the first server 1301 to be added to the list 1320. The first server 1301 adds a computer or server to the list 1320 after qualifying it. The first server 1301 analyzes the input set and its generalizations and specializations, or inductions and deductions submitted by the intelligent assistant agent controller 1120. For searches, reasonings, categorizations and rankings that will benefit from external ontologies, knowledge bases, or expert systems, the first server 1301 formulates them into knowledge base and expert system inquires and directs the inquiries to the appropriate computers or servers on the list that run the appropriate ontologies, or knowledge bases, or expert system web services 1320. The first server 1301 receives answers from such computers or servers, compiles such answers, combines the answers with results obtained on the first server 1301 if there is any, and sends the results to the user.

Similar to the previous embodiments, the first server 1301 provides supporting evidence and reasoning for associations, and provides multidimensional, and user selectable ranking methods to the user. These results may be obtained using information on the first server 1301, or from other computers or servers accessed by the first server 1301. In one embodiment, the results may be sent to the user by the first server 1301 and presented as summaries and detailed information. The detailed information may presented in reports that will require a fee from the user for the service provided by the server. To avoid the user waiting for downloading such reports, the reports can be automatically sent to the user in an encrypted format or protected by a password. The first server 1301 may send the decryption key or password to the user when he clicks a link indicating that he wants to read the report and accept the charges. The user will not be charged if he does not wish to read the reports. The charges may be on a per-report basis or as a subscription plan. In the case the first server 1301 obtained a result from a service provided by second computer or server, the first server 1301 may record an appropriate portion of the charge paid by the user as due to the owner of the second computer or server.

Although the foregoing descriptions of the preferred embodiments of the present invention have shown, described, or illustrated the fundamental novel features or principles of the invention, it will be understood that various omissions, substitutions, and changes in the form of the detail of the methods, elements or apparatuses as illustrated, as well as the uses thereof, may be made by those skilled in the art without departing from the spirit of the present invention. Hence, the scope of the present invention should not be limited to the foregoing descriptions. Rather, the principles of the invention may be applied to a wide range of methods, systems, and apparatuses, to achieve the advantages described herein and to achieve other advantages or to satisfy other objectives as well. Thus, the scope of this invention should be defined by the appended claims.

1. A method comprising:
extracting one or more search elements from at least one designated file in one or more processing devices;
generating one or more search requests using the extracted search elements;
submitting the generated search requests to a search program; and
receiving search results from the search program.

2. The method of claim 1, wherein a search element is one or more of the following:
one or more keywords; a characteristic of a file; a category of a file; a textual description of a preference of the search; and an objective of the search.

3. The method of claim 1, further comprising responsive to a user viewing, writing, editing or processing a file in an application program, designating the file so that the one or more search requests are generated using the file.

4. The method of claim 1, further comprising displaying the search results associated with a search element extracted from the at least one designated file in one or more of the following conditions: when search results are received from a search program; when the search element in the at least one designated file is currently displayed in an application program's window; and when the user selects the search element in the at least one designated file.

5. The method of claim 1, further comprising incorporating one or more hyperlinks with a search element or element combination in a file, and responsive to the user using an input device to select one or more of the hyperlinks, displaying the search results associated with the search element or element combination.

6. The method of claim 1, further comprising performing one or more of the following processes on the search results: filtering; categorizing; ranking; and extracting an abstract or summary from the search results.

7. The method of claim 1, wherein the one or more search requests include requests to search one or more of the following: files in one or more specified sources; files that are listed in or linked to entries in a recent document folder; and files that are recorded in or linked to items that are recorded in a web browser's history log or favorites folder of the user.

8. The method of claim 1, further comprising:
generating repeated search requests;
submitting the generated search request to a search program over a period of time based on a schedule; and
receiving search results from the search program.

9. The method of claim 8, further comprising detecting changes between search results of a first search performed at a first time and a second search performed at a second time later than the first time, and informing a user when a change is detected.

10. The method of claim 9, wherein detecting changes between the second search results and the first search results further comprises comparing a digital digest computed from the second search results with a digital digest computed from the first search results.

11. The method of claim 9, wherein the repeated search requests comprise search requests for searching a list of specified sources, and further comprising detecting changes in the sources listed in the first list of specified sources.

12. The method of claim 1, further comprising responsive to a user using an input device to designate a file, generating one or more search requests from the file selected by the user, executing a search program on a processing device operated by the user to search files stored in one or more storage devices communicatively coupled with the processing device operated by the user to carry out the one or more search requests, and displaying names of or links to files that are found by the search program based on the one or more search requests generated from the file selected by the user.

13. A method comprising:
extracting a first predicate or proposition from a textual content of one or more information entities;
generalizing the first predicate or proposition to a first set of one or more generalized predicates or propositions that are related to the first predicate or proposition, wherein the first predicate or proposition is a member of the first set of one or more generalized predicates or propositions; and
processing the one or more information entities or the textual content of the one or more information entities from which the first predicate or proposition is extracted, based on the first set of one or more generalized predicates or propositions.

14. The method of claim 13, wherein an information entity is one or more of the following: a file in a storage device; an input provided by a user; a database; a program; a log of one or more users' activities over a period of time; and a file that a user is currently reading, writing or editing, or has recently read, written or edited.

15. The method of claim 13, wherein generalizing the first predicate or proposition comprises replacing at least one part of the first predicate or proposition with a description that captures at least one semantic meaning of the replaced part.

16. The method of claim 13, wherein processing the textual contents of the one or more information entities comprises one or more of the following: categorizing or ranking the information entities or textual content of the information entities; determining whether a generalized predicate or proposition has a relationship with another predicate or proposition; and submitting a first generalized predicate or proposition from the first set of one or more generalized predicates or propositions to a search program to find one or more files that contain a second predicate or proposition that has a relationship with the first generalized predicate or proposition.

17. A method comprising:
analyzing contents of one or more storage devices;
identifying, within the contents of the one or more storage devices, files that are related;
creating and recording links between the files that are related; and
displaying recorded links to files related to a first file when the first file is selected or opened in an application window.

18. The method of claim 17, wherein identifying files that are related comprises identifying two files as related if both contain the same or similar keywords, concepts, predicates, propositions, patterns, both are related to the same transaction or project, both are created, edited or viewed within a same period of time, or both are authored by the same person or related persons.

19. A method comprising:
providing a user interface that accepts a first description of a search and one or more lists of links from a user, wherein the one or more lists of links comprise one or more of the following: a list of URL links in a history log of a web browser; a list of links in a favorites folder of a web browser; a list of links to files in a recent documents folder; and a list of links to files in a set of designated folders; and
obtaining search results from a search of files that are linked by an entry in the one or more lists of links and containing information that matches the first description.

20. The method of claim 19, further comprising one of more of the following: providing a user interface that allows a user to select which lists of links to be included; providing a user interface that allows a user to define a list of links are to be included; providing a user interface that allows a user to use one or more lists of links located on another processing device on a network; accessing or downloading the files that are linked to in the one or more lists of links, and performing on a processing device operated by a user the search in the files that are linked to in the one or more lists of links for information or files that contain information that match the first description; and grouping search results obtained from a list of links into a category for the list of links.
